(19) United States
(12) Patent Application Publication
(10) Pub. No.: US 2012/0089486 A1
(43) Pub. Date: Apr. 12, 2012

(54) MANAGING PROCESS REQUESTS IN A DISTRIBUTED ORDER ORCHESTRATION SYSTEM

(75) Inventors: Fred MAHAKIAN, Erie, CO (US); John STICKLEY, Walnut Creek, CA (US); Samuel WONG, Happy Valley (HK); Yan CUI, Cupertino, CA (US); Praveen VIPRANARAYANAN, Belmont, CA (US)

(73) Assignee: ORACLE INTERNATIONAL CORPORATION, Redwood Shores, CA (US)

(21) Appl. No.: 12/900,816

(22) Filed: Oct. 8, 2010

(51) Int. Cl. G06Q 30/00

(52) U.S. Cl. 705/26.81

(57) ABSTRACT

A fulfillment workbench of a distributed order orchestration system is provided. A distributed order orchestration system can include a fulfillment workbench that provides a user interface for order fulfillment administrators, users and supervisors to monitor and manage order fulfillment processes through the distributed order orchestration system. The fulfillment workbench can receive a process request from a user to modify an ongoing order fulfillment process, where the process request includes one or more line requests, transmit the process request to one or more fulfillment systems, and provide a process request status to the user. The fulfillment workbench can provide a process request status to the user even though the process request interacts with one or more fulfillment systems, and the timing of the response to the process request may not be known.

### FIELD

One embodiment is directed to a computer system generally, and more particularly to a computer system for monitoring and modifying an orchestration of business processes.

### BACKGROUND

Order management systems are computer software and/or hardware systems implemented by a number of industries to facilitate order entry and processing. Companies, such as catalog companies and those utilizing electronic commerce, use order management systems to receive, process and fulfill customer orders. An order management system makes possible the entering of an order via a website shopping cart or data entry system. The system typically captures customer proprietary information and/or account level information for each order. Credit verification or payment processing may then be performed to check for available funds and validate the transaction. Valid orders are processed for warehouse fulfillment, including, picking, packing and shipping of the ordered goods or services.

Business processes are typically modeled by business architects/analysts. A business process may model message exchanges with different systems in a web services environment. The business architects/analysts then provide an information technology (“IT”) designer with the model. The IT designer uses an orchestration language, such as business process execution language (“BPEL”), to code the business process. BPEL processes are typically created in a BPEL editor and a deployed BPEL process is invoked. BPEL provides orchestration logic which can be mapped to a business process. BPEL is also standard-based and provides programming paradigms such as data types, if-else statements, switch statements, loops, method invocation, variables definition, and fault handling. BPEL supports all message exchange patterns, and supports both asynchronous and synchronous service invocations. Thus, some communications with external fulfillment systems will have a synchronous response, and some communications will have an asynchronous response.

The nature of this interaction has a direct effect on an order manager who is looking at all of the orders that are getting fulfilled. Part of the order manager's job is to correct issues as they arise by taking action. In nearly all cases, the order manager's action will cause some communication to be sent to one or many external fulfillment systems.

### SUMMARY

One embodiment is directed to a computer-readable medium having instructions stored thereon that, when executed by a processor, cause the processor to manage a process request. The instructions include transmitting a process request to one or more fulfillment systems, where the process request modifies a fulfillment process, and where the process request comprises one or more line requests. The instructions further include displaying a first indication indicating that the process request is complete in a user interface, when the process request completes, and displaying a second indication indicating that the process request is processing in the user interface, when a predetermined timeout period elapses before the process request completes. The instructions further include displaying a status for each line request of the one or more line requests in the user interface, and automatically updating the status for each pending line request of the one or more line requests in the user interface, when each pending line request completes.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates an example of a distributed order orchestration system according to one embodiment.

FIG. 2 illustrates a flowchart for processing an order according to one embodiment.

FIG. 3 illustrates an example of a system for providing an orchestration process design and authoring environment in a context of order fulfillment according to one embodiment.

FIG. 4 illustrates an example of an interface according to one embodiment.

FIG. 5 illustrates the runtime operation according to one embodiment.

FIG. 6 illustrates an example of invocation of services using a flow sequencer according to one embodiment.

FIG. 7 illustrates a process for orchestration data flow among different layers according to one embodiment.

FIG. 8 illustrates a flowchart of a method for changing an executable process according to one embodiment.

FIG. 9 illustrates a block diagram of a fulfillment workbench that may implement an embodiment of the present invention.

FIG. 10 illustrates a user interface of a fulfillment workbench according to an embodiment of the invention.

FIG. 11 illustrates a user interface of a fulfillment workbench displaying an indication that a process request is being processed according to an embodiment of the invention.

FIG. 12 illustrates a user interface of a fulfillment workbench displaying an indication that the process request is complete according to an embodiment of the invention.

FIG. 13 illustrates a user interface of a fulfillment workbench displaying an indication that the process request is still processing according to an embodiment of the invention.

FIG. 14 illustrates a user interface of a fulfillment workbench according to another embodiment of the invention.

FIG. 15 illustrates a flow diagram of a fulfillment workbench transmitting a process request to a set of fulfillment systems according to an embodiment of the invention.

FIG. 16 illustrates a flow diagram of a fulfillment workbench displaying an indication that a process request is complete according to an embodiment of the invention.

FIG. 17 illustrates a flow diagram of a fulfillment workbench displaying an indication that a process request is still processing according to an embodiment of the invention.

FIG. 18 illustrates a flow diagram of a fulfillment workbench updating a request status for a first line request according to an embodiment of the invention.

FIG. 19 illustrates a flow diagram of a fulfillment workbench updating a request status for a second line request according to an embodiment of the invention.

FIG. 20 illustrates a flow diagram of a fulfillment workbench updating a request status for a third line request according to an embodiment of the invention.

FIG. 21 illustrates a flow diagram of the functionality of a fulfillment workbench module according to an embodiment of the invention.

### DETAILED DESCRIPTION

### Distributed Order Orchestration Framework

One embodiment is directed to a distributed order orchestration system (“DOO”). Distributed order orchestration provides a flexible, configurable infrastructure that can be easily customized to be consistent with an enterprise's business practices and existing order fulfillment system architecture. Decomposition is the conversion of data received from one or more order capture modules into an internal canonical format in order to process the data. In one example embodiment, the distributed order orchestration system includes a capture layer for capturing customer orders across multiple channels, a decomposition layer to help determine the orchestration process, an orchestration layer for executing and orchestrating order line processing, a task layer services for performing task related logic, an external interface layer for interfacing with external systems, a fulfillment layer, and a global order promising layer to provide a user interface for scheduling and sourcing. The distributed order orchestration system may further include a fulfillment workbench layer that interfaces with the other layers of the system and manages sources, tasks and assignments. The various layers of the distributed order orchestration system described above combine to provide a complete order management solution at reduced implementation and maintenance costs. However, in an alternative embodiment, the capture layer is not part of the distributed order orchestration system. In this alternative embodiment, an order capture layer is part of a separate system, and a connector service is utilized as a bridge between the distributed order orchestration system and the capture layer.

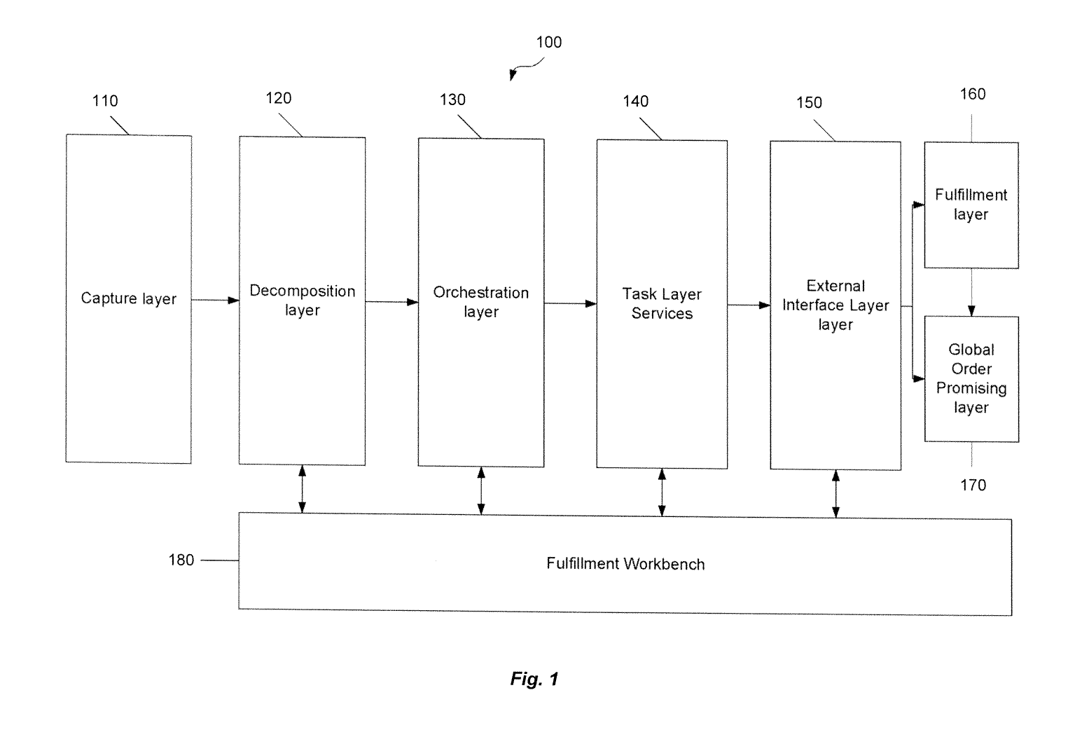

FIG. 1 illustrates an example of a distributed order orchestration system 100 according to one embodiment. In the embodiment, distributed order orchestration system 100 includes a capture layer 110 that can receive and capture information related to customer orders for goods and/or services across multiple channels. The order may be received via a graphical user interface, such as that of a website shopping cart, or can be received via any data entry system. The capture layer 110 captures and forwards the order information to a decomposition layer 120. However, in an alternative embodiment, the capture layer 110 is separate from distributed order orchestration system 100. In this alternative embodiment, a connector service is utilized as a bridge between distributed order orchestration system 100 and capture layer 110.

Order Capture systems capture the order with any necessary functional attributes that are needed to process the order, such as pricing, validation, eligibility, etc. The sales order is fed to decomposition layer 120 in a Source Order object. The source order object is generated from a sales order object submitted by different capture systems. The source order object is in a generic format that is fed into the decomposition layer 120.

Decomposition layer 120 receives the order information and breaks the received order into individual purchase orders to be sent to fulfillment systems and supply-side partners for execution. Decomposition layer 120 may include a decomposition rules workbench for setting up rules, rule sets, and transformation processes for the order capture layer 110 may capture the order from a sales perspective. For example, a laptop computer may be sold worldwide. The laptop includes a power cord, but the customer just buys a laptop (one line on the order). That is, a sales website may want to just sell the laptop and not have the customer individually order the power cord separately. However, from a fulfillment perspective, the laptop and the power cord need to be retrieved for the order. In decomposition layer 120, there may be a business rule that says that a laptop must have a power cord and the plug on the power cord must match the country to which the laptop is shipped. So when decomposition module 120 is complete, the order has two lines, one with the laptop and one for the appropriate power cord. Thus, the order has been decomposed into multiple items that need to be fulfilled.

Also, decomposition layer 120 may take the received order and translate it to the order format and order content required by the other layers of the distributed order orchestration system 100, such as the fulfillment layer 160. Because capture layer 110 is capable of receiving orders in any format for compatibility purposes across different types of systems, decomposition layer 120 may need to translate the order into a format that is compatible with and can be recognized by all the other layers and/or processes of the distributed order orchestration system 100. Additionally, decomposition layer 120 may provide a process launch capability to assign and launch orchestration processes for an order based on appropriate decomposition rules. For example, different orchestration processes are assigned based on parameters in the order. For example, a company may give special treatment to certain customers in terms of speed of fulfillment or shipping. For example, Gold customers may be offered expedited shipping. Also, there may be an additional step for communication with the customer. When the orders for these customers are received, they are assigned to the orchestration process that has these parameters and steps while orders for other customers may be assigned to standard processes.

Decomposition may use a canonical object model to accomplish the decoupling of data format from order capture systems. Decomposition integration processes work on a set of generic data structures called Enterprise Business Objects (EBO's). They are based on the canonical data model. This approach allows the DOO to be agnostic of participating applications and be independent of source or target applications. The model eliminates the need to map data from different applications directly to each other.

Distributed order orchestration system 100, as illustrated in FIG. 1, further includes an orchestration layer 130. Orchestration layer 130 provides individual orchestration processes to manage order and/or service line items. For example, orchestration layer 130 may provide business process management functionality to support planning of steps within a process, including step duration and calculation or recalculation of completion dates. Orchestration layer 130 may also provide external task execution functionality to support creation, update, release, and monitoring of external tasks. External tasks are those that are carried out by the fulfillment systems. Task layer services do specific processing and then send the data to these integrated fulfillment systems. Orchestration is a sequence of task layer service invocations.

Orchestration layer 130 may also provide for jeopardy management in order to check a promised delivery date of an order against current estimated date for completion, map to user defined thresholds, and handle or escalate conditions. Orchestration layer 130 may further provide a process for change orders, including a support process rollback to accommodate for change order automation and modify in-flight orchestration processes for orders changed in order capture stage. Further, a projected order completion date may be provided by instantiating the orchestration process. Orchestration layer 130 also provides a mechanism for updating an order status automatically or upon user request.

One embodiment provides a tool that provides a high degree of abstraction for business process modeling in an order fulfillment business process. Business processes may be modeled by users, such as business analysts, and do not need any coding from an IT designer to have the business process executed. Users are provided the flexibility to define business processes in a central place configured to enter and capture all information required for orchestration and fulfilling an order. An example of such a central place can be a web-based administration user interface. Likewise, an example of all information required for orchestration and order fulfillment may be information required for process planning, core orchestration, and change management. The business process may identify one or more services that define steps to be performed in the order fulfillment process. A run-time engine then uses the definition to dynamically invoke the services based on the definition of the business process.

In the business environment, business users are often process modelers, not IT personnel. By providing a web-based administration environment, the business users may be able to design the business process. The process definitions may be defined in business terms and not in IT terms. Particular embodiments allow an administrative environment outside of a code editor, such as a BPEL editor, for defining processes using associated services. Users can configure processes that can be executed at runtime as executable processes without IT involvement. This alleviates the need for deploying the processes every time a modification of the business process is needed. The user sets up the sequence of services on a data table. The modeled business process is then used to perform an executable process (also identified as an orchestration process), which is assembled and executed at run-time. In one embodiment, “runtime” can be defined as the time when an order is received for processing. Metadata is assembled in a data runtime table and used to define the executable process for the business process. The metadata is used to invoke services in the executable process.

In one embodiment, the services invoked are encapsulated and reusable. The metadata is used to determine how and when to invoke services. Also, depending on the metadata, input arguments are generated and sent to the services to invoke the encapsulated service. A common signature is used to send data to invoke the services. Different input arguments can be formulated for different services used in different executable processes. The input arguments are formatted in the same way such that a service can read the different sets of data and invoke the service. Thus, services can be re-used in different business processes without the need to be recoded and redeployed. Deployment of services indicates the process is ready to be released for testing or production.

Distributed order orchestration system 100 may further include a task layer services 140 to provide encapsulated services used to control processing logic for each orchestration process stage. In particular, task layer services 140 may provide task-specific business logic to wrap logic around a certain request such that the system 100 knows what logical tasks are associated with a particular request. The steps that need to be performed in the executable process from orchestration may require tasks to be performed. For example, task layer services 140 can provide and control processing logic for scheduling a shipment, requesting a shipment, updating an install base, creating an activity, etc. The output of task layer services 140 is a standard goods and/or service request(s) which may be provided to other layers of the system 100, such as external interface layer 150 or fulfillment layer 160. In addition, task layer services 140 may receive input that can be used to update the processing logic or status.

Task layer services 140 initiates the task, generates a message for an external system, and sends the message. The data structure that is needed to have the task performed is generated. Certain tasks may be predefined in task layer services. Also, a customer may add other tasks using a template that defines how to create a task. The message generated indicates which task should be performed by the external system. The task to be performed is an aspect of order processing that has been modeled. For example, the task may be invoicing for an order. Parameters for performing the task are also included. The message is sent to an external interface of external interface layer 150. Task layer services 140 transforms and sends the message to the external system layer.

Distributed order orchestration system 100 also includes an external interface layer 150 to translate standard request(s) and route the request(s) to external systems for processing. More specifically, external interface layer 150 may receive the standard goods and/or services request(s) output by the task layer services 140 and provide a single layer transform of the request(s) if needed to match the format of fulfillment systems. The transformation performed by external interface layer 150 maps the data to the content and format required by the integrated fulfillment systems. Transformation by decomposition layer 120 converts the data to the internal format used by system 100. External interface layer 150 may map the data structure from task layer services 140 to the external format. External interface layer 150 provides flexible routing so that request(s) are routed to specific fulfillment systems based on business rules. For example, if more than one shipping system is available for fulfillment, business rules will determine to which shipping system an individual shipping request will be sent. External interface layer 150 may also include a transformation rules workbench that can be utilized to setup rules, rule sets, and transformation data for external routing of request(s).

The messages generated by the task layer may be in a generic format. Different external systems, however, may communicate using other formats. The external interface layer determines the format used by an external system and transforms the message. For example, metadata defined by a user may be used to determine the format to be used. In one example, mappings to what external systems call a product that was ordered are used to translate the message.

The external systems may be systems that perform the task related to processing an order, such as a scheduling system, shipping system, etc. When the task is performed, the result of the task is determined. The result may be a date when a shipment is scheduled, a date when a good is shipped, etc. The result is then sent back to external interface layer 150.

Distributed order orchestration system 100 may further include a global order promising layer 170 that provides an interface, such as a graphical user interface, for scheduling and sourcing orders. In particular, in one embodiment, global order promising layer 170 includes a sourcing broker that determines the best source for products and services associated with the order based upon a customer profile, order and supplier definitions, etc. Also, global order promising layer 170 provides for real-time reserve and un-reserve of inventory and inventory check across distributed internal systems. The interface of global order promising layer 170 allows for the viewing of availability and sourcing information so that a user can view the availability of and manually change the source from which an order for a good or service is being fulfilled. However, in an alternative embodiment, the global order promising layer 170 is separate from distributed order orchestration system 100. In this alternative embodiment, a connector service is utilized as a bridge between distributed order orchestration system 100 and global order promising layer 170.

A fulfillment workbench 180 may also be provided as a user interface for order fulfillment administrators, users and supervisors to monitor and manage the flow of orders through the system 100. In an embodiment, fulfillment workbench 180 provides users, such as supervisors, with a mechanism to monitor order fulfillment tasks, including allowing supervisors to monitor activity load and to produce reports. Fulfillment workbench 180 further provides a fulfillment process analysis that allows business process designers to analyze process metrics such as the number of manual interventions, the number and type of errors that occurred, the number of late orders, and the expected process duration versus the actual duration. In certain embodiments, a fulfillment system performance analysis capability is also included within the fulfillment workbench 180 to provide reports and dashboards to enable order managers to view orders for each system and analyze performance. The fulfillment workbench may make use of graphical representations (e.g., graphs and charts) to clearly convey system status/order information to users. Because DOO system 100 has the data reference data, it is possible to draw aggregated graphs/charts for trending analysis. Users may take actions from the fulfillment workbench as described below, such as by substituting the item ordered, splitting the quantity into multiple order lines, putting a hold on the order lines to prevent further progression, etc.

According to one embodiment, fulfillment workbench 180 allows users to make mass order information changes related to fulfillment including making single line or mass line changes to fulfillment information (e.g., dates, etc.). Fulfillment workbench 180 may further allow for the monitoring of orchestration processes, such as reviewing the status of orchestration processes including overall process progress, as well as status of individual tasks and corresponding fulfillment lines and people lines. Fulfillment workbench 180, in one embodiment, includes mechanisms for maintaining order fulfillment processing and allows an order processing user to control a process associated with an order including pause, edit, cancel, etc.

In some embodiments, fulfillment workbench 180 also provides functionality for order and task assignment. For example, fulfillment workbench 180 may use an assignment engine to assign orders and activities to the appropriate fulfillment resource. Fulfillment workbench 180 may include a mechanism for batch re-assignment of orders thereby allowing a supervisor to re-source a set of orders from one fulfillment system to another. Fulfillment workbench 180 also provides for the assignment of fill rate and backorder rules that can automatically determine how to handle shortage situations. A universal in-box may be included within fulfillment workbench 180 in order to allow users to view activities assigned to them and respond to the task.

Fulfillment workbench 180 allows a user to view orders being processed in different layers of system 100. A view of the status of an order may be generated from whichever layers have processed the order. This is because an end to end integrated system has been provided. Conventional order systems may have been customized solutions that did not allow for a view of different layers. By integrating layers in a format that allows generic communication, a user interface that can generate views from all the layers can be provided.

Examples of distributed order orchestration system 100 may also include a fulfillment layer 160. In one embodiment, fulfillment layer 160 may be an interface to external fulfillment systems, and can be used to communicate order information and fulfillment requirements to a supplier or source of the goods and/or services associated with an order.

Certain embodiments of distributed order orchestration system 100 include an administration user interface. The administration user interface provides administration services that hide the complexity of the fulfillment execution environment from the end user. For instance, the administration user interface provide product mapping via an administration environment that defines transformations to map product structure between a sales view and a supplier system definition. In this embodiment, sales view refers to a simplified view provided to consumers when making a purchase order. Supplier system definition refers to the more specific and detailed information used by suppliers of goods and/or services. The administration user interface may also provide an orchestration process workbench to set up processes, rule sets, and parameters for order orchestration. The administration user interface has an integrated setup that includes process sequence, planning, jeopardy, change management, and workbench display. The administration user interface also allows for user-defined status transitions for tasks, processes, and fulfillment lines, and business rules configuration for configuring constraints, transformation rules, and routing rules.

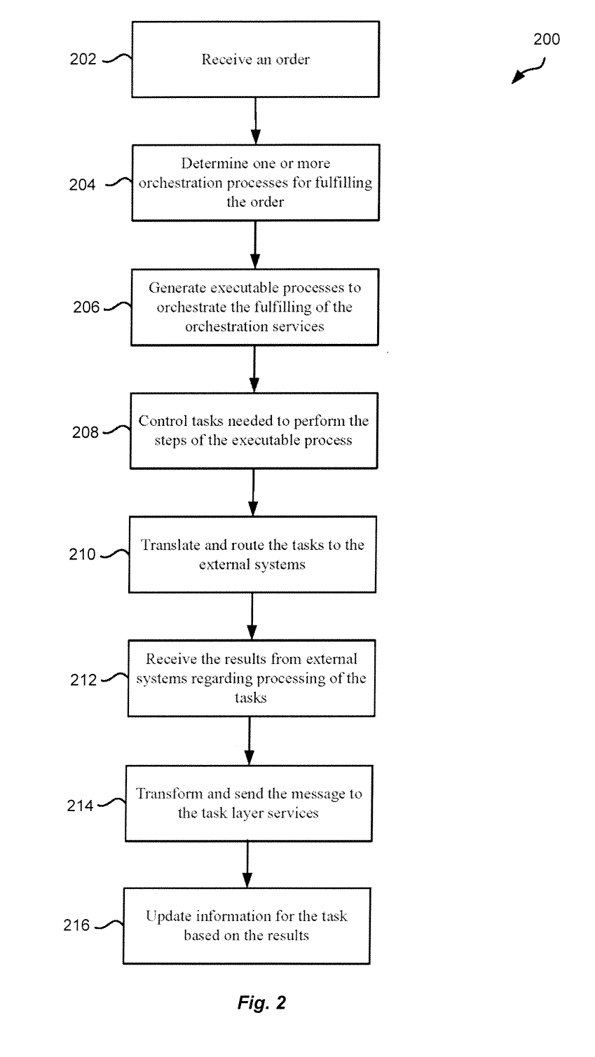

FIG. 2 depicts a simplified flowchart 200 for processing an order according to one embodiment. In step 202, decomposition layer 120 receives an order. In step 204, decomposition layer 120 determines one or more orchestration processes for fulfilling the order. For example, the order may be decomposed into items that need to be procured or services that need to be performed. Each item or service may have its own orchestration service.

In step 206, orchestration layer 130 generates executable processes to orchestrate the fulfilling of the orchestration services. The executable processes may have multiple steps that need to be performed for each orchestration service.

In step 208, task layer services 140 controls business functions needed to perform the steps of the executable process. Tasks to be performed for the executable process may include setting up a data structure with information and parameters that are needed to have external systems perform the tasks. The data structure may be in an internal format for system 100. For example, the task may be invoicing for an order. Parameters for performing the task are also included.

In step 210, external interface layer translates and routes the tasks to the external systems. Different external systems, however, may communicate using other formats. The external interface layer determines the format used by an external system and transforms the message. For example, metadata defined by a user may be used to determine the format to be used. In one example, mappings to what external systems call a product that was ordered are used to translate the message.

In step 212, external interface layer 150 receives the results from external systems regarding processing of the tasks. When the task is performed, the result of the task is determined. The result may be a date when a shipment is scheduled, a date when a good is shipped, etc.

In step 214, external interface layer 150 transforms and sends the message to the task layer services 140. In step 216, orchestration layer updates information for the task based on the results. For example, the results may be stored in a table or database. The process then continues to the next service that can be invoked.

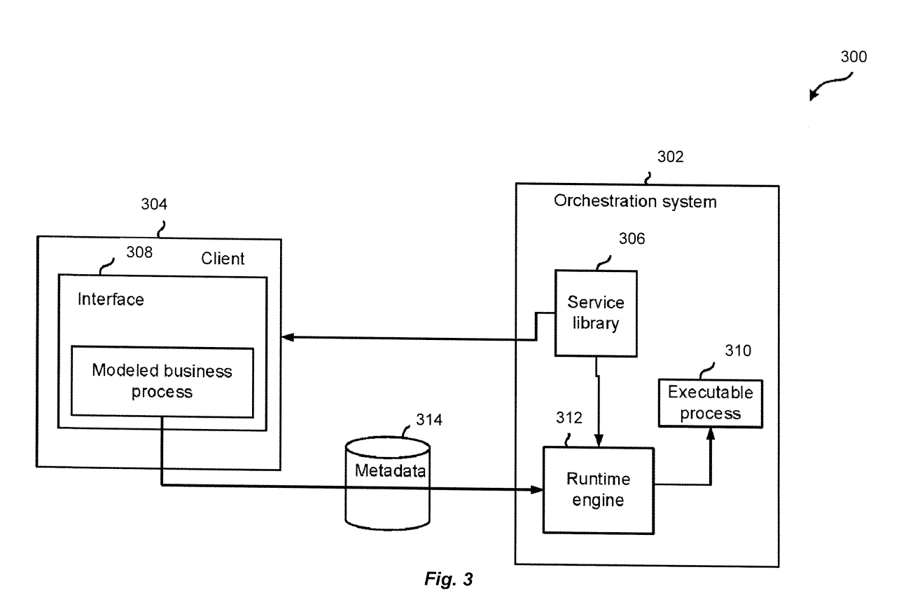

Further implementation details of orchestration are now described in relation to FIGS. 3-8, and in accordance with an embodiment of orchestration that utilizes a flow sequencer. However, one of ordinary skill in the art will readily appreciate that further details are merely an example of orchestration, and that orchestration may be implemented in many different embodiments, including alternative embodiments that do not utilize a flow sequencer. For example, orchestration may be implemented according to the details described in U.S. patent application Ser. No. 12/697,756, entitled “ORCHESTRATION OF BUSINESS PROCESSES USING TEMPLATES.”

FIG. 3 illustrates a system 300 for providing an orchestration process design and authoring environment in a context of order fulfillment according to one embodiment. In the embodiment, system 300 includes an orchestration system 302 and a client 304. Although single instances of orchestration system 302 and client 304 are provided, it will be understood that multiple instances may be used. Also, orchestration system 302 and client 304 may be part of a distributed computing system. That is, functions described may be distributed among various computing devices.

Client 304 may be a computing device or set of computing devices that are configured to allow a business process to be modeled. Orchestration system 302 orchestrates the invocation and running of services for an executable process 310 for the business process. Orchestration, as described, is the coordination and invoking of services that need to be performed in the business process.

As used, a business process may be modeled by a user. The business process is a definition of steps to be performed. The steps are defined in interface 308. An executable process is the process that is executed by run-time engine 312. The executable process includes code that is executed to coordinate performing of services.

A service library 306 that includes multiple services that can be included in a business process. In one embodiment, a service library 306 includes services that can be performed in an order fulfillment business process. Order fulfillment involves processes that are performed to fulfill an order. For example, an order may be received from an order capture module. The order may be for a good, service, etc. Different services may be performed to fulfill the order, such as shipment, installation, invoicing, etc. The order fulfillment process may be characterized in these different services. It is expected for any given order, some or all of these processes may need to be performed to fulfill the order. Accordingly, particular embodiments create services for the services that are expected to be performed in an order fulfillment process.

Services may be non-configurable units and configurable units. Nonconfigurable units are services that are built and provided to customers. The nonconfigurable units are units that likely may be used in an order fulfillment process. For example, it is expected that different services may have to be performed in the order fulfillment process, such as account receivable. Accordingly, these services may be modeled using a language, such as BPEL. Although BPEL is described, one of ordinary skill in the art would readily understand that other languages may be used.

Configurable units are services that are built and defined by a customer. For example, a wrapper is provided around a service that is configured by a user. For example, a customer may want a shipping service that is specific to the customer's company. Accordingly, the service performed by the configurable unit may be defined and built by a customer, but the wrapper allows runtime engine 312 to invoke the service automatically. This allows customers to define services that are needed for their individual organizations.

The services may be re-used in different business processes. The services are encapsulated and configured to receive a common signature for the service to be performed. For example, for each business process, different parameters may be provided (i.e., different products may be ordered for different prices, etc.). This causes different input arguments to be inputted into the service. The common signature defines a data structure that allows the service to be re-used for different executable processes 310. Thus, the same deployed service is used to process different input arguments for the different orders, but different results may be obtained. In this way, the order fulfillment process can be abstracted. Different users can define which services need to be performed without regard to how the processes are coded in an orchestration language.

Interface 308 may be an administration user interface. For example, a graphical user interface allows a user to model a business process at an abstract level. For example, service library 306 may be provided to client 304. The user may then use interface 308 to define steps of the business process using services in service library 306. A user may define a plurality of steps in the business process. Each step may be associated with a service in service library 306. The steps may be stored in a data table, which may include metadata that may be used by runtime engine 312 to orchestrate executable process 310. The data table is shown as being stored in storage 314. It will be understood that the data table may be stored in any area, such as in client 304, orchestration system 302, or any other device. The metadata may be defined by the user, determined from data tables, and/or orchestration rules. The user defines the sequence in which the services are to be invoked as well as conditional or parallel branching that may be required to affect the business processing rules. When the user selects a service for a process step, the user also provides additional metadata that is used to determine how the processing data is to be executed during the processing of an order at runtime. For example, conditional or parallel branching is defined.

At runtime, runtime engine 312 receives the metadata and uses it to determine parameters for the orchestration of executable process 310. Runtime engine 312 uses the parameters to determine which steps to perform and when to perform them in executable process 310. For example, runtime engine 312 orchestrates executable process 310 by invoking services in the series of steps that have been defined by the user. As will be described in more detail below, parallel and conditional processing of steps can also be performed. Also, the metadata can be used to determine the input arguments used to invoke the services.

The metadata for the table is read at runtime and services are invoked, which allows changes to executable process 310 to be performed and realized at runtime automatically. Runtime engine 312 reads through each step that is defined and performs the steps. If a change in service is desired, the user may use interface 308 to add/delete/replace a service. At run-time, when the table is read, the change may be automatically performed.

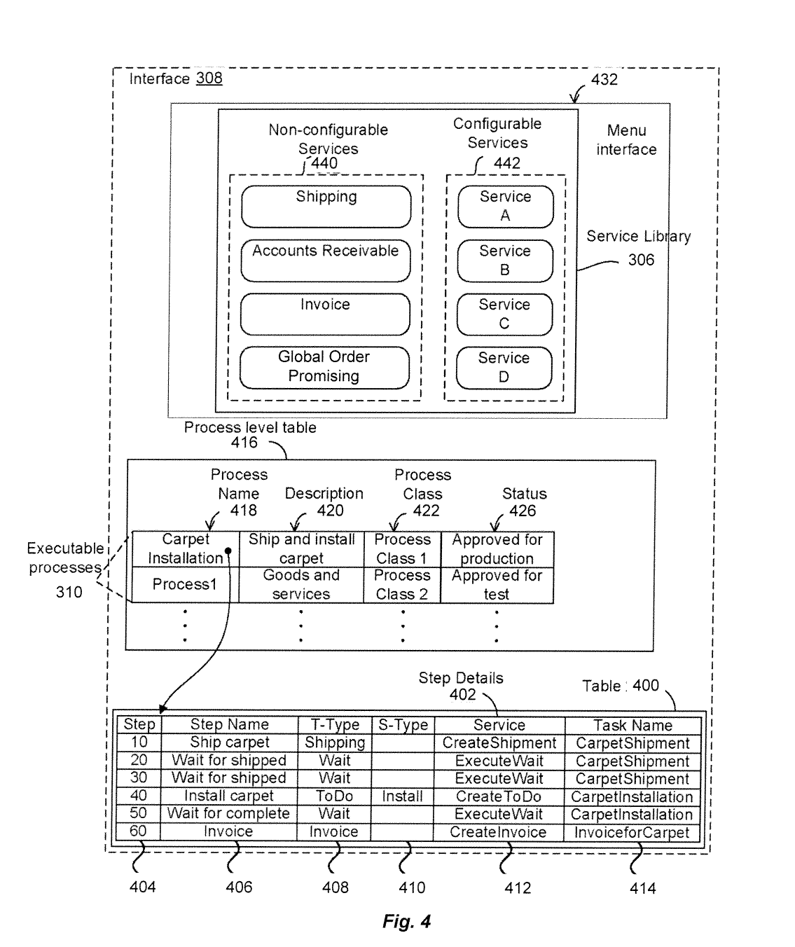

FIG. 4 illustrates an example of an interface 308 according to one embodiment. Process level table 416 summarizes different business processes that have been modeled. As shown, the business processes—Carpet Installation and Process 1—have been modeled by a user.

In process level table 416, a process name column 418 shows business processes carpet installation business process and process 1 have been modeled. A description column 420 describes the process. A process class column 422 describes the class of the process. A status column 426 is the status of the executable process. There may be different statuses of executable processes 310. For example, some business processes may be approved for production, approved for test, or may be new. Approved for production means that the service is approved for regular business use, approved for test is approved for testing, and new is a service in development.

A business process in table 416 can be selected and data table 400 may show the step details for individual business processes. One business process is entitled Carpet Installation and a data table 400 of step details shows each service that has been defined for the Carpet Installation.

In data table 400, a step column 404 identifies the steps in the business process. For example, steps 10-60 are provided. Services for these steps may be performed at runtime. The steps may be run in sequence from top to bottom (or in any other order). In this case, a step 10 is performed and when finished, a step 20 is performed, and so on. Additionally, although not shown, conditional and parallel steps may also be defined using interface 308. Conditional steps are steps that depend on a result occurring (e.g., another step finishing) and parallel steps are performed in parallel. A user defines whether steps should be conditional or parallel.

Step name column 406 provides a descriptive name for the steps. For example, ship carpet, wait for shipped, install carpet, wait for complete, and invoice steps are provided.

A task type column 408 describes what type of task is being performed. For example, for the ship carpet task, an external system may perform a shipping task and for the invoice step, an invoice system may invoice for a bill.

A service column 412 identifies the service associated with the step. A task name column 414 is the name of the task. For example, those tasks have to do with carpet and are named carpet shipment, carpet installation, and invoice for carpet. If something other than a carpet is being installed, the task name will be different. For example, a sink shipment, sink installation, and invoice for sink may be the names of these tasks.

Users may use interface 308 to generate data table 400. A user may select services from a menu for service library 306. For example, a user uses a menu interface 432 to select services from service library 306. Drop-down menus, drag-and-drop options, and other visual processes may be used to define executable process 310. Users are provided with an orchestration-specific interface that presents the business process data with suitable validations, rather than being required to learn the complexities of a multipurpose IT development environment. This allows a user to model a business process in an abstract manner, but have executable process 310 be generated and executed from the model.

The services in service library 306 may be made up of non-configurable units and configurable units. For example, non-configurable units are provided in a column 440 and configurable units are provided in a column 442. As shown, services that are non-configurable include shipping, accounts receivable (“AR”), invoice, and global order promising (“GOP”). Also, configurable units are designated as A, B, C, and D. Table 400 is generated as shown in interface 308 using menu 412. Table 400 is associated with metadata that describes the services to be performed and any arguments that are needed to invoke the services.

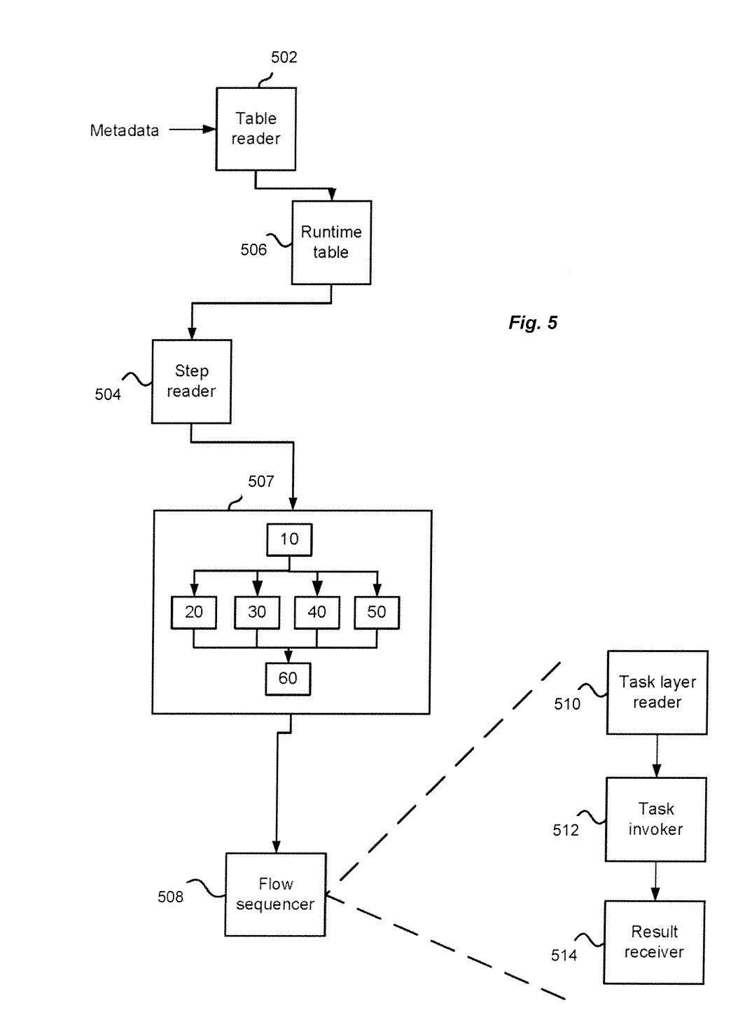

Once the business process is modeled in interface 308 and released by setting the process status, runtime engine 312 is used to orchestrate the invocation of the services. FIG. 5 illustrates the runtime operation according to one embodiment. In the embodiment, a table reader 502 receives metadata from interface 308 defining the business process. Table reader 502 may copy the data to a runtime table 506 but this is not necessary.

During run-time, a step reader 504 is configured to read the steps in runtime table 506, according to the embodiment. Step reader 504 may analyze the metadata and determine which steps should be executed and when. For example, step reader 504 checks to see if parallel or conditional branching is associated with a step. The metadata is also used to determine input arguments for the services. The input arguments may be determined from the metadata, from data in lookup tables, or determined using rules.

Step reader 504 may assemble executable process 310 using encapsulated services from service 306 and the metadata, according to the embodiment. For example, code for each service that was modeled in the steps is determined for executable process 310. The input arguments for each service are also determined. For example, the metadata is used to determine the input arguments such that the services can process an order for the business process. Also, any partner links are determined using the metadata to allow the services to interact with external systems. Executable process 310 is assembled based on the definition of steps in the business process. Because services are reusable, the same code for a service can be used for different business processes. However, the input arguments or partner links may be different. Because the same code is re-used, automatic assembly of executable process 310 is provided.

In the embodiment, a flow sequencer 508 is used to dynamically invoke the steps at the appropriate time based on executable process 310. As shown in box 507, a step 10 may determine a service to invoke. One of steps 20, 30, 40, and 50 are then performed. Step 60 then determines if other steps need to be performed. In this case, one of the other steps in 20, 30, 40, and 50 could be performed. Flow sequencer 508 may determine relevant input arguments depending on the content of the metadata received. These input arguments are then used to invoke a service. For example, flow sequencer 508 may include a task layer reader 510 that determines a service to invoke. A task invoker 512 then dynamically invokes the service. Any input arguments are used to invoke the service. In invoking the service, code for the encapsulated service is executed to coordinate performing of the service. For example, the executed code may prepare and send a message to an external system to perform the service.

The service may then be performed and the result is received at result receiver 514. In one example, if the task is shipping, then a shipping service generates a message for a shipping system regarding the shipping of a good. Once the shipping system ships the good, a message is returned to the shipping service, which stores the result.

After receiving a result, it is then checked whether further sequences need to be performed. For example, a while activity module checks to see whether further services need to be processed. For example, the process may be returned to flow sequencer 508 to allow for dynamic invocation of other steps in the process. Also, the while activity module may wait until parallel branches are completed.

Accordingly, the information required to invoke the services is determined automatically based on the runtime table. In one example, in BPEL, necessary partner links for all invocations have been created and are used to invoke the services. The services represented in the BPEL partner links are deployed BPEL processes that require no further configuration in order to be used in multiple business process definitions. When a service is invoked by the runtime engine, the corresponding partner link is accessed in the underlying BPEL process. Assembly of a service and modification of any service take place through the use of the metadata found in the runtime table and may be managed through interface 308.

Accordingly, a user can set up the steps in a business process. Executable process 310 can be automatically assembled at run-time. The code used in executable process 310 is not generated by the user who set up the business process. Rather, metadata can be defined and is used to assemble encapsulated services for executable process 310.

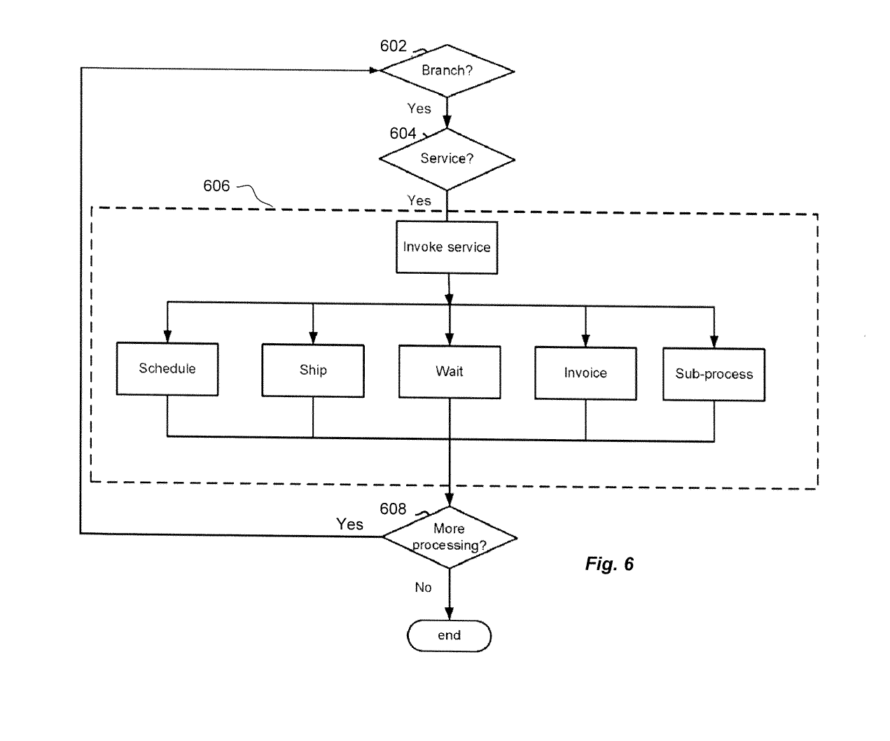

FIG. 6 illustrates an example of invocation of services using flow sequencer 508 according to one embodiment. At step 602, according to the embodiment, it is determined if branching is needed. If a conditional statement is encountered, the process proceeds down the appropriate branch based on which condition is satisfied. If parallel branching is encountered, parallel flow sequence instances are spawned to carry out the additional branches. The branching is determined and used later in invoking services. The process then proceeds to step 604 in which a service is determined.

Various services may then be performed. The steps include an invoke service step, schedule step, ship step, wait step, invoice step, and sub-process step. Identical processing sequences can flow in parallel until a unifying step is reached. Each flow sequence contains the same underlying coded process (such as a BPEL process), but different processing sequences can be used in different executable processes 310. That is, one sequence may contain Schedule, Ship, Invoice while another may contain Schedule, Activity, Ship, Activity, Invoice, although the runtime engine including the underlying coded processes do not change. That is, the code for each service that is invoked stays the same even though different executable processes are being run.

An external service invocation is contained in each branch of the flow sequencer, one branch for each service that can be invoked. The branch contains all the steps necessary to set up the data that should be included in the message to the specific external service and to format the response received from the service. Once a service is complete, the while activity module checks to see if there are further services to process and either returns to flow sequencer 508, continues to the next step in the process or waits until any parallel branches are complete.

Box 606 shows a conceptual execution of executable process 310. Not all steps may be run at once. For example, the invoke service is invoked for step 10 and determines a service to invoke. Once that is completed, step 608 determines if other steps need to be performed. In this case, step 604 determines the Schedule, Ship, Wait, Invoice, and subprocesses services should be performed. Once all the flows have been completed, a uniform set of results can be constructed. Based on the definition of the executable process, it is determined if additional processing should be performed. Different branches are performed where each branch invokes the associated service. Input arguments for the service are generated from the metadata in the runtime table. When the selected service has been performed, step 608 determines if additional services should be performed. If so, the process reiterates to step 602. If not, the process ends.

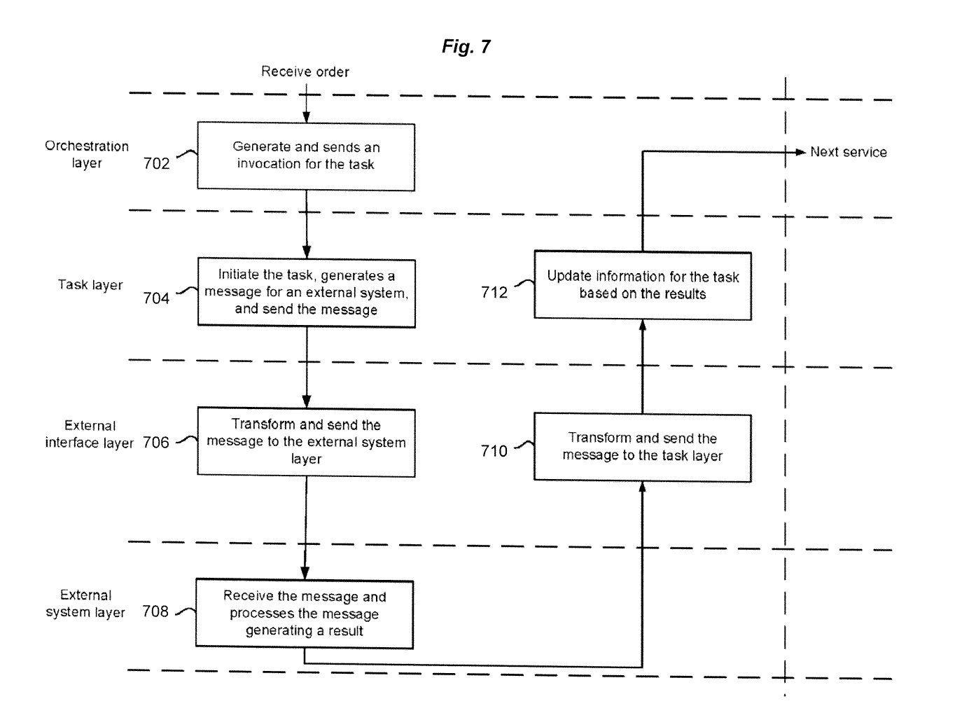

The orchestration of services is provided using information from table 400. However, in addition to orchestration, services need to communicate with external systems. FIG. 7 illustrates a process for orchestration data flow among different layers according to one embodiment. An orchestration layer, task layer, external interface layer, and external system layer is provided. In one embodiment, a decomposition layer (not shown) is provided before an orchestration layer.

Step 702 generates and sends an invocation for the task, according to the embodiment. An order may be received from an order capture module. This may cause a task to be invoked. The invocation request is generated using data found in the runtime table. The request is sent to the task layer.

Step 704 initiates the task, generates a message for an external system, and sends the message, according to the embodiment. The message generated indicates which task should be performed by the external system. The task to be performed is an aspect of order processing that has been modeled. For example, the task may be invoicing for an order. Parameters for performing the task are also included. The message is sent to an external interface.

Step 706 transforms and sends the message to the external system layer, according to the embodiment. The messages generated by the task layer may be in a generic format. Different external systems, however, may communicate using other formats. The external interface layer determines the format used by an external system and transforms the message. For example, metadata defined by a user may be used to determine the format to be used. In one example, mappings to what external systems call a product that was ordered are used to translate the message.

Step 708 receives the message returned by the external system and processes the message generating a result, according to the embodiment. The external systems may be systems that perform the task related to processing an order, such as a scheduling system, shipping system, etc. When the task is performed, the result of the task is determined. The result may be a date when a shipment is scheduled, a date when a good is shipped, etc. The result is then sent back to the external interface layer.

In the embodiment, step 710 transforms and sends the message to the task layer. Step 712 updates information for the task based on the results. For example, the results may be stored in a table or database. The process then continues to the next service that can be invoked.

By using encapsulated services that are defined using interface 308, changes can be made to an executable process 310 and implemented at runtime. For example, alterations to the metadata during the running of the process can influence the sequence of steps taken as well as the input arguments of the individual steps.

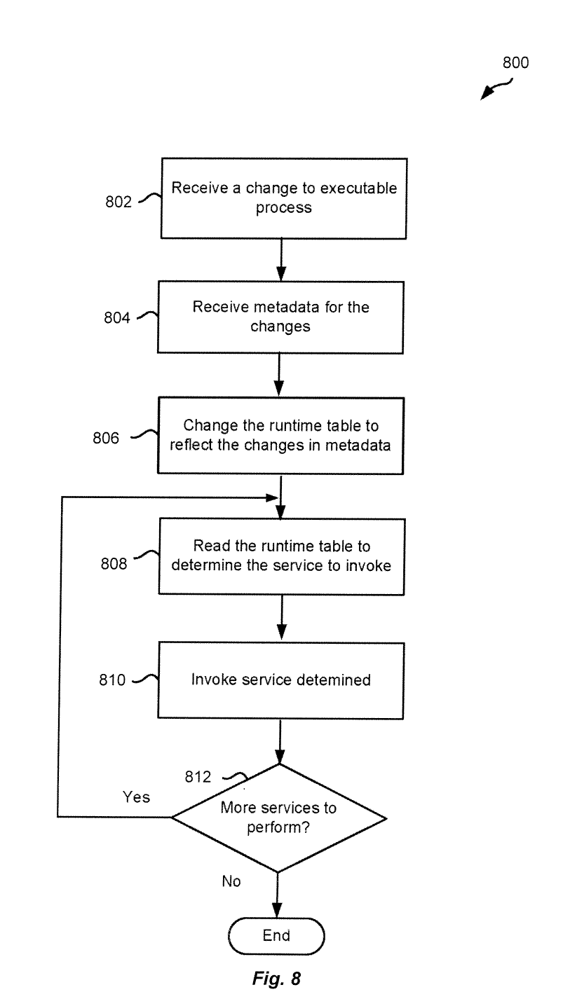

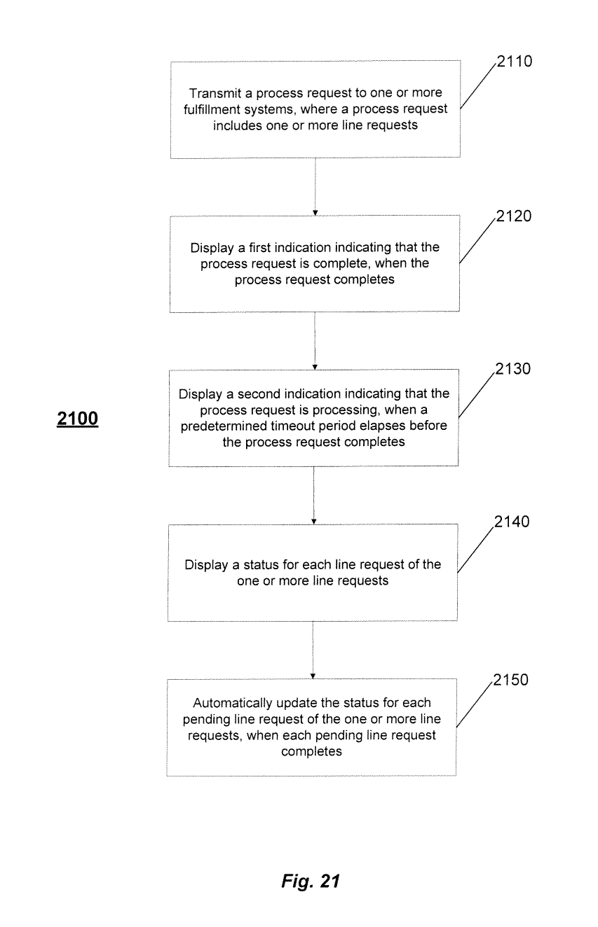

FIG. 8 illustrates a flowchart 800 of a method for changing a business process according to one embodiment. In one embodiment, the functionality of flowchart 800 of FIG. 8, as well as the functionality of flowchart 2100 of FIG. 21, is implemented by software stored in memory or other computer-readable or tangible media, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

Step 802 receives a change to the business process. For example, interface 308 is used to change the business process to include different steps. In one example, steps may be replaced, steps may be deleted, or steps may be added.

Step 804 receives metadata for the changes. For example, runtime engine 312 may receive the changed metadata. Step 806 then changes the runtime table to reflect the changes in metadata. For example, executable process 310 may be changed to include different services to invoke.

When a service is to be invoked, step 808 reads the runtime table to determine the service to invoke. For example, step reader 504 may be reading the table during the processing of executable process 310. If the runtime table has been changed, step reader 504 determines the next step that needs to be performed based on the changes.

Step 810 then invokes the service determined. Because services can be called based on different input arguments, additional programming to re-deploy the new service is not needed when services in the business process are changed. Rather, the table may just be changed and different service can be automatically invoked.

Step 812 then determines if more services need to be performed. If so, the process reiterates to step 806 where the table is read again to determine the next step to perform. If not, the process ends.

Accordingly, data-driven orchestration provides abstraction and flexibility. The abstraction refers to the web-based administration of process metadata that defines the process steps in an executable process. Process code is re-used across different business processes. Flexibility refers to the ability to modify the processes without re-deployment of code. The use of changes to runtime metadata facilitates changes to executable process 310. Abstraction brings the process model closer to the business user and reduces administrative costs. Flexibility allows a business user to respond to change, such as the modification of process specifications when business processes or rules change.

Furthermore, a DOO order (“order”) is an object that represents an order received from an order capture module, and that has been transferred into an object format utilized by an orchestration system. The order is capable of including a distributed order orchestration header (“header”). A header is an object that contains the entire hierarchy of the order. The order is capable of including one or more groups, where a group is an entity used to collect distributed order orchestration order lines (“lines”) for processing in a single instance of an orchestration process. Each group is capable of including one or more lines. A line is an object that contains the information of the corresponding line of the order. Each line is capable of including one or more distributed order orchestration fulfillment lines (“fulfillment lines”). A fulfillment line is an object that corresponds to a supply action of a corresponding fulfillment system which is capable of processing the order line. Thus, a fulfillment line is a supply line that fulfills the corresponding fulfillment task.

Further implementation details of orchestration are described in U.S. patent Ser. No. 12/617,698, entitled “DISTRIBUTED ORDER ORCHESTRATION,” U.S. patent application Ser. No. 12/718,585, entitled “CHANGE MANAGEMENT FRAMEWORK IN DISTRIBUTED ORDER ORCHESTRATION SYSTEM,” and U.S. patent application Ser. No. 12/697,756, entitled “ORCHESTRATION OF BUSINESS PROCESSES USING TEMPLATES.”

### Fulfillment Workbench

One embodiment is directed to a fulfillment workbench of a distributed order orchestration system. As previously described, a distributed order orchestration system can include a fulfillment workbench that provides a user interface for order fulfillment administrators, users and supervisors to monitor and manage order fulfillment processes through the distributed order orchestration system. According to the embodiment, the fulfillment workbench can receive a process request from a user to modify a fulfillment process, where the process request includes one or more line requests, transmit the process request to one or more fulfillment systems, and provide a process request status to the user. The fulfillment workbench can provide a process request status to the user even though the process request interacts with one or more fulfillment systems, and the timing of the response to the process request may not be known.

In an embodiment, the fulfillment workbench can provide a notification, via the user interface, to the user that the process request is complete. Alternatively, the fulfillment workbench can provide a notification, via the user interface, to the user that the process request is still processing after a predetermined timeout period has elapsed. After a predetermined timeout period has elapsed, the fulfillment workbench can provide subsequent notifications that indicate that each line request of the process request that is pending has completed until the entire process request has completed.

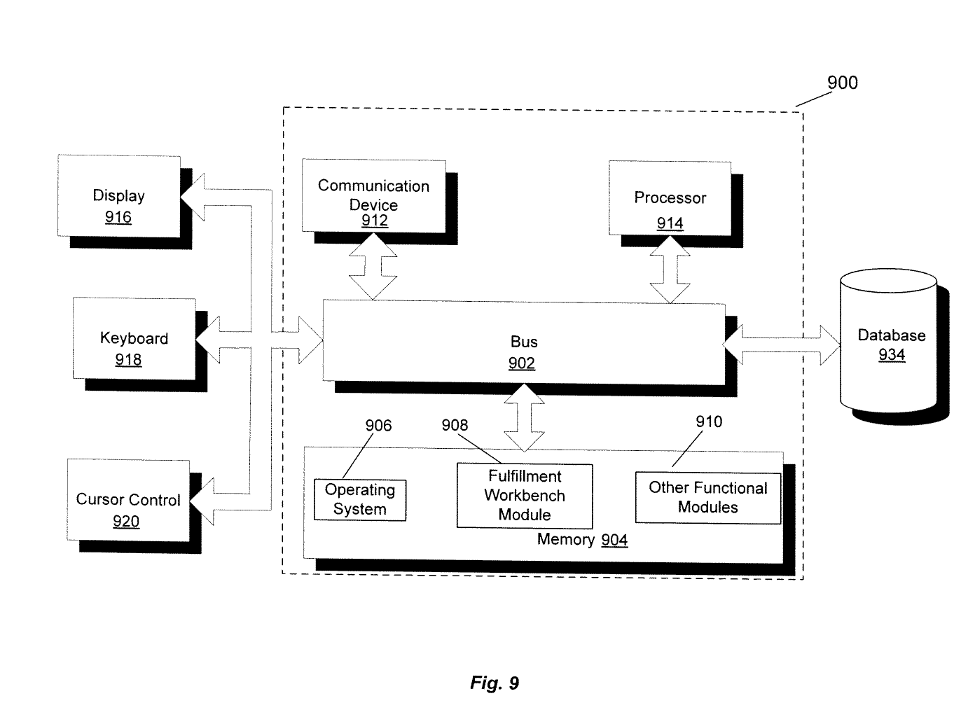

FIG. 9 illustrates a block diagram of a fulfillment workbench 900 that may implement one embodiment of the invention. Fulfillment workbench 900 includes a bus 902 or other communications mechanism for communicating information between components of fulfillment workbench 900. Fulfillment workbench 900 also includes a processor 914, operatively coupled to bus 902, for processing information and executing instructions or operations. Processor 914 may be any type of general or specific purpose processor. Fulfillment workbench 900 further includes a memory 904 for storing information and instructions to be executed by processor 914. Memory 904 can be comprised of any combination of random access memory (“RAM”), read only memory (“ROM”), static storage such as a magnetic or optical disk, or any other type of machine or computer-readable medium. Fulfillment workbench 900 further includes a communication device 912, such as a network interface card or other communications interface, to provide access to a network. As a result, a user may interface with fulfillment workbench 900 directly or remotely through a network or any other method.

A computer-readable medium may be any available medium that can be accessed by processor 914. A computer-readable medium may include both a volatile and nonvolatile medium, a removable and non-removable medium, a communication medium, and a storage medium. A communication medium may include computer readable instructions, data structures, program modules or other data in a modulated data signal such as a carrier wave or other transport mechanism, and may include any other form of information delivery medium known in the art. A storage medium may include RAM, flash memory, ROM, erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

Processor 914 can also be operatively coupled via bus 902 to a display 916, such as a Liquid Crystal Display (“LCD”). Display 916 can display information to the user. A keyboard 918 and a cursor control device 920, such as a computer mouse, can also be operatively coupled to bus 902 to enable the user to interface with fulfillment workbench 900.

According to one embodiment, memory 904 can store software modules that may provide functionality when executed by processor 914. The modules can include an operating system 906, a fulfillment workbench module 908, as well as other functional modules 910. Operating system 906 can provide an operating system functionality for fulfillment workbench 900. Fulfillment workbench module 908 can provide functionality for managing a process request, as will be described in more detail below. Fulfillment workbench 900 can also be part of a larger system. Thus, fulfillment workbench 900 can include one or more additional functional modules 910 to include the additional functionality. For example, functional modules 910 may include modules that are part of the “Fusion” product from Oracle Corporation.

Processor 914 can also be operatively coupled via bus 902 to a database 934. Database 934 can store data in an integrated collection of logically-related records or files. Database 934 can be an operational database, an analytical database, a data warehouse, a distributed database, an end-user database, an external database, a navigational database, an in-memory database, a document-oriented database, a real-time database, a relational database, an object-oriented database, or any other database known in the art.

As previously described, a fulfillment workbench allows a user to monitor a fulfillment process, such as an order fulfillment process in a distributed order orchestration system. The fulfillment workbench also allows a user to determine if the fulfillment process is in trouble and requires manual intervention. For example, according to an embodiment, the distributed order orchestration system can receive an order and provision the order, by, in part, transmitting a provisioning request to a shipping fulfillment system to initiate a provisioning process and ship a corresponding product from a warehouse located in Indianapolis. However, if the Indianapolis warehouse does not have a sufficient supply of the corresponding product, the shipping fulfillment system will not be able to complete the provisioning process. The status of the provisioning process can be monitored by the fulfillment workbench. Based on the monitoring of the provisioning process, a user can determine that it needs to manually intervene with the provisioning process, in order to complete the provisioning process. Such an intervention, according to the embodiment, may include transmitting a process request to the shipping fulfillment system, via the fulfillment workbench, to modify the provisioning process to ship the product from a warehouse located in Denver rather than Indianapolis. According to the embodiment, the fulfillment workbench can provide a user interface that allows a user to submit a process request as described above.

In modifying a fulfillment process in a distributed order orchestration system, a fulfillment workbench can communicate with one or more fulfillment systems, such as transmitting a process request to the one or more fulfillment systems to modify the fulfillment process. However, because a fulfillment system can be an external system, it may not be known how much time will elapse before a response is received from the fulfillment system. In certain scenarios, it may be many hours or days before a response is received form the fulfillment system. Because a user may not wish to wait for a response from the fulfillment system before performing another task, an asynchronous request-response model, rather than a synchronous request-response model can be used, so that the user is not required to wait for a response. According to an embodiment of the invention, the fulfillment workbench can mediate a user's interaction with an external fulfillment system through the use of an asynchronous response-request model and by displaying a status of a process request to the user, as will be described below in more detail.

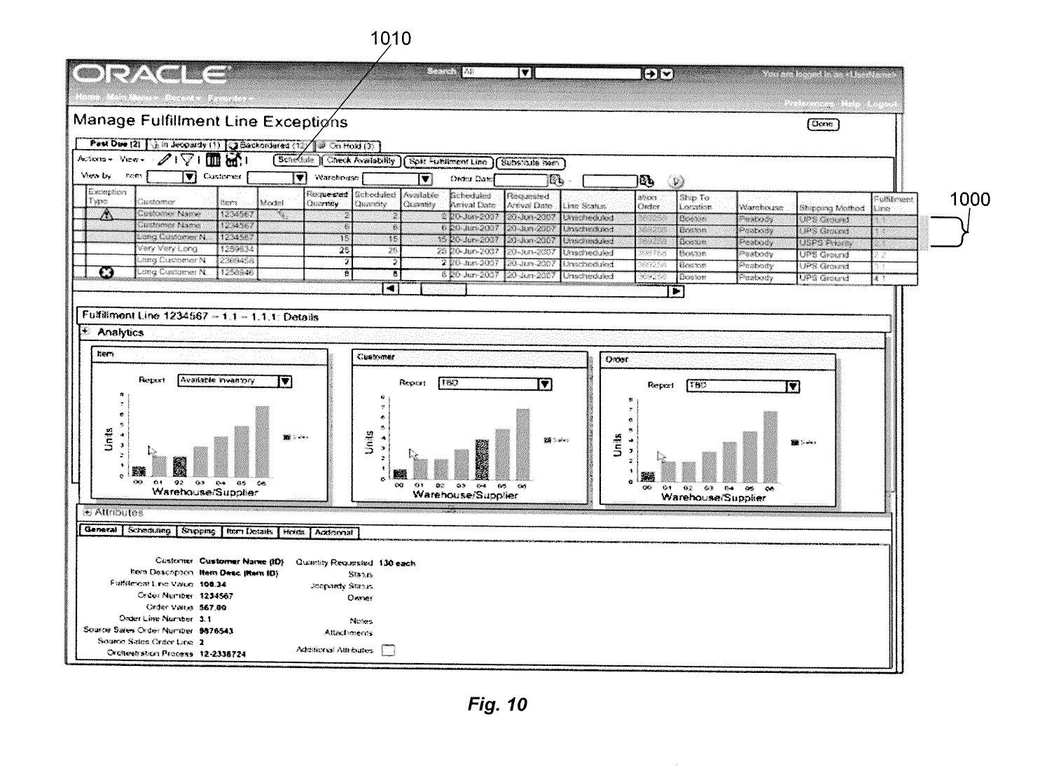

FIGS. 10-14 illustrate a user interface of a fulfillment workbench that can be used to modify a fulfillment process in a distributed order orchestration system, according to an embodiment of the invention. In the illustrated embodiment, a user modifies a fulfillment process by manually scheduling three fulfillment lines. However, one of ordinary skill in the art would readily appreciate that this is merely an example of a modification of a fulfillment process and that a user can modify a fulfillment process in different ways and still be within the scope of the invention. Such different ways can include substituting an item in an order, splitting a quantity of an order into multiple order lines, and putting a hold on order lines to prevent further progression.

FIG. 10 illustrates a user interface of a fulfillment workbench according to an embodiment of the invention. According to the illustrated embodiment, the user interface displays a set of fulfillment lines. Each fulfillment line is part of an order that is being processed by the distributed order orchestration system. As illustrated in FIG. 10, a user can select fulfillment lines 1000 using the user interface of the fulfillment workbench and can manually schedule the fulfillment lines from the fulfillment workbench using schedule button 1010 of the user interface. According to the embodiment, fulfillment lines 1000 may be selected because they are identified by the fulfillment workbench as requiring manual intervention. For example, in one embodiment, the fulfillment workbench can identify that each fulfillment line of fulfillment lines 1000 has an assigned schedule date that is prior to the current date, and thus, each fulfillment line is past due. By selecting the schedule button 1010, the fulfillment workbench can transmit a process request to one or more appropriate fulfillment systems. According to the embodiment, the process request is comprised of a line request for each fulfillment line of fulfillment lines 1000.

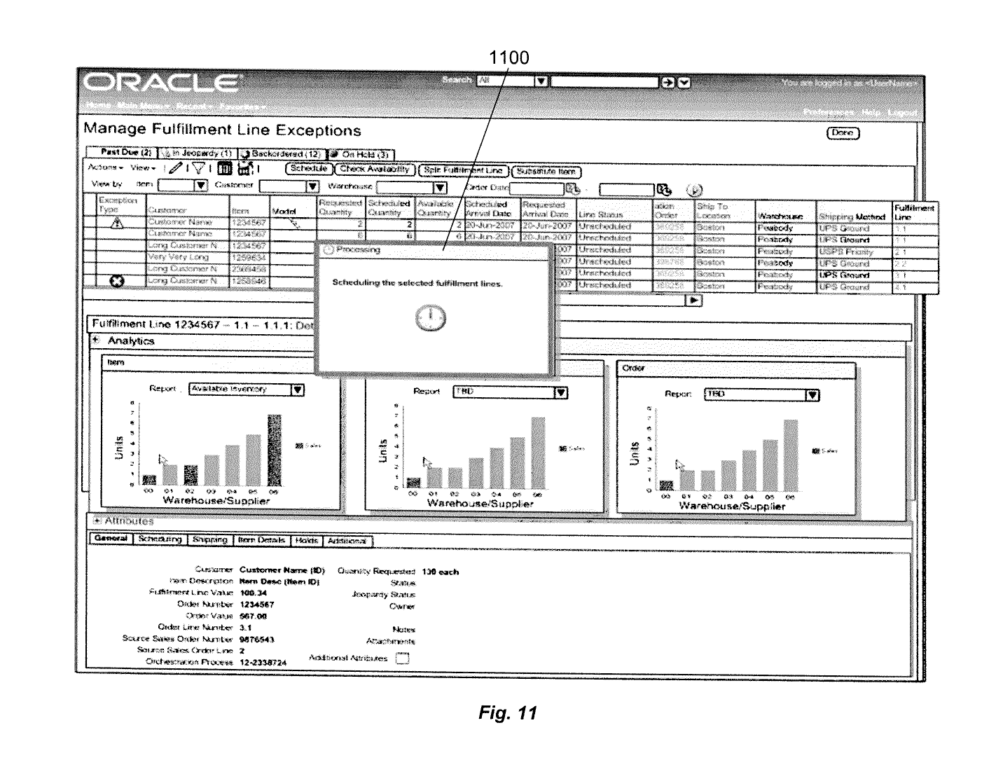

FIG. 11 illustrates a user interface of a fulfillment workbench displaying an indication that a process request is being processed according to an embodiment of the invention. According to the illustrated embodiment, the user interface displays indication 1100 after a user has selected schedule button 1010 illustrated in FIG. 10 as previously described. In the embodiment, indication 1100 indicates that the fulfillment workbench is scheduling selected fulfillment lines 1000 of FIG. 10. Furthermore, at the same time that the user interface displays indication 1100, the fulfillment workbench asynchronously transmits a process request to one or more fulfillment systems to schedule the fulfillment lines. According to the embodiment, the process request includes three line requests, where each line request is a request to schedule an individual fulfillment line. According to the embodiment, the user interface displays indication 1100 until the process request is completed by the one or more fulfillment systems, or until a predetermined timeout period has elapsed. According to an embodiment, a predetermined timeout period is a system parameter with a value of a specific period of time. Example values of a predetermined timeout period include, but are not limited to, 1 second, 5 seconds, 60 seconds, and 300 seconds. A predetermined timeout period can be set to a default value, or can be configured by a user of the fulfillment workbench.

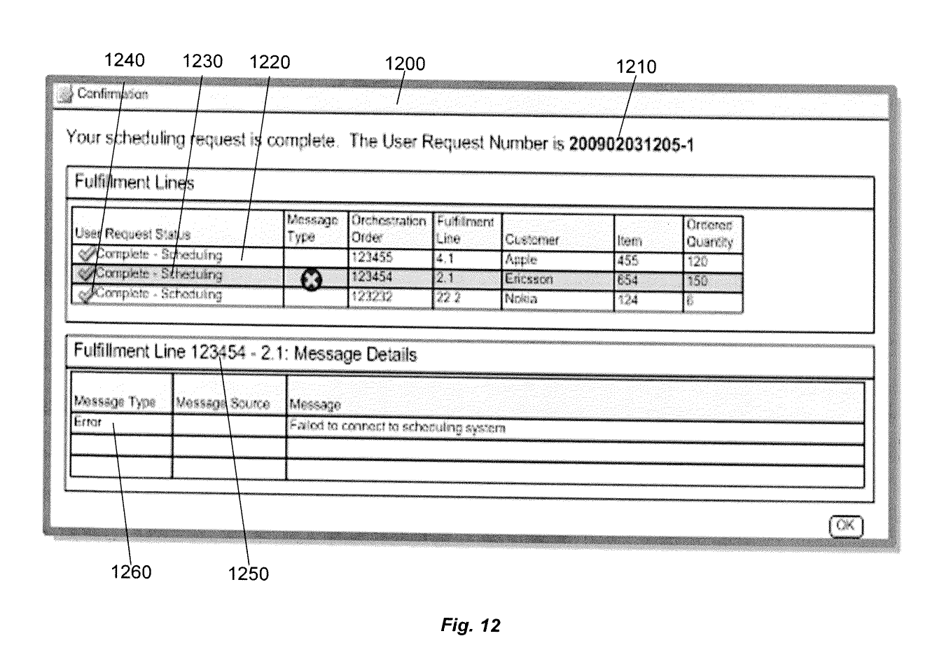

FIG. 12 illustrates a user interface of a fulfillment workbench displaying an indication that the process request is complete according to an embodiment of the invention. According to the illustrated embodiment, the user interface displays indication 1200. Indication 1200 is displayed by the user interface when the process request is completed by the one or more fulfillment systems. As shown in FIG. 12, indication 1200 indicates that the process request initiated by the fulfillment workbench is complete. According to an embodiment, indication 1200 also includes a unique identifier 1210 which identifies the process request. In the illustrated embodiment, unique identifier 1210 is user request number 200902031205-1.

As also shown in FIG. 12, indication 1200 indicates a status for each of the three fulfillment lines, statuses 1220, 1230, and 1240. Because indication 1200 indicates that the process request is complete, this means that the three line requests are complete as well. Thus, the indicated status for each fulfillment line is complete for status 1220, status 1230, and status 1240. This indicates that the process request completed, and a response was received from one or more fulfillment systems.

According to the illustrated embodiment of FIG. 12, indication 1200 includes message details 1250. Message details 1250 includes any response, such as an error message, received from one or more fulfillment systems. Indication 1200 includes message details 1250, because an indicated status of complete for a line request does not necessarily mean that the fulfillment line was correctly scheduled. Instead, an indicated status of complete for a line request means that the line request was sent by the fulfillment workbench to the one or more fulfillment systems, and either a response was received by the one or more fulfillment systems, or the fulfillment workbench has ceased attempting to communicate with the one or more fulfillment systems. However, either scenario does not necessarily mean that the line request was successful. For example, a fulfillment system may have encountered an error while attempting to schedule a fulfillment line, and the fulfillment system may have ceased processing the line request and sent an error message to the fulfillment workbench. As another example, the fulfillment workbench may have attempted to transmit a line request to one or more fulfillment systems, but the fulfillment workbench has not received a response form the one or more fulfillment systems, and thus, has finished attempting to transmit the line request to the one or more fulfillment systems. From the fulfillment workbench's perspective, the line request is complete, even though the fulfillment line was not scheduled. Thus, indication 1200 includes message details 1250, so that a user can review the completed process request in order to determine if any error messages were received by the fulfillment workbench, and if so, what the error messages are, in order to determine if any supplemental steps need to be taken.

In the illustrated embodiment of FIG. 12, message details 1250 includes error message 1260. Error message 1260 indicates that the corresponding fulfillment line was not scheduled because the fulfillment workbench failed to connect with the one or more fulfillment systems (in this case a scheduling system). While in the illustrated embodiment, message details 1250 includes error message 1260, one of ordinary skill in the art would readily appreciate that this is an example embodiment, and that in alternate embodiments, each completed line request initiated by the fulfillment workbench may not result in any errors, and thus, messages details 1250 will not include any error messages.

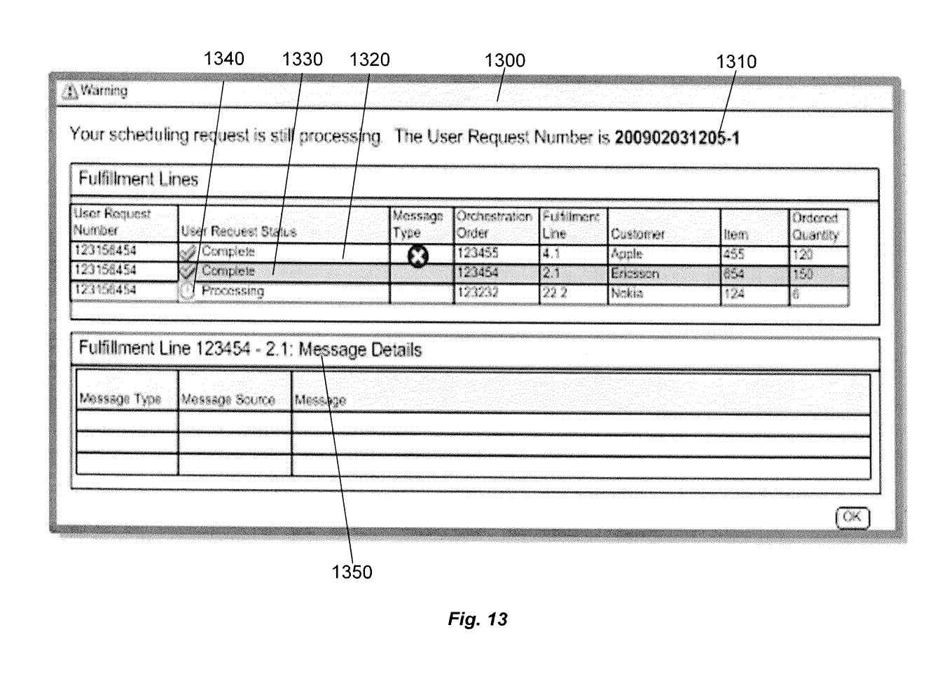

FIG. 13 illustrates a user interface of a fulfillment workbench displaying an indication that the process request is still processing according to an embodiment of the invention. According to the illustrated embodiment, the user interface displays indication 1300. Indication 1300 is displayed by the user interface after a predetermined timeout period has elapsed. As shown in FIG. 13, indication 1300 indicates that the process request initiated by the fulfillment workbench is still processing. According to an embodiment, indication 1300 also includes a unique identifier 1310 which identifies the process request. In the illustrated embodiment, unique identifier 1310 is user request number 200902031205-1. A process request that is processing after the predetermined timeout period has elapsed is also identified as a pending process request.

As also shown in FIG. 13, indication 1300 indicates a status for each of the three fulfillment lines, statuses 1320, 1330, and 1340. According to the embodiment, because indication 1300 indicates that the process request is still processing, this means that one or more of the three line requests is still processing, and thus, one or more of the indicated statuses for the fulfillment lines is processing rather than complete. In the illustrated embodiment, the status for statuses 1320 and 1330 is complete, but the status for status 1340 is processing. This means that two of the line requests have completed, but a third line request is still processing. A line request that is processing after the predetermined timeout period has elapsed is also identified as a pending line request.

According to the illustrated embodiment of FIG. 13, indication 1300 includes message details 1350. Similar to message details 1250 of FIG. 12, message details 1350 includes any response, such as an error message, received from one or more fulfillment systems. In the illustrated embodiment, message details 1350 does not include any error messages. However, one of ordinary skill in the art would readily appreciate that this is an example embodiment, and that in alternate embodiments, messages details 1350 can include error messages which indicates errors encountered in processing each of the line requests transmitted by the fulfillment workbench.

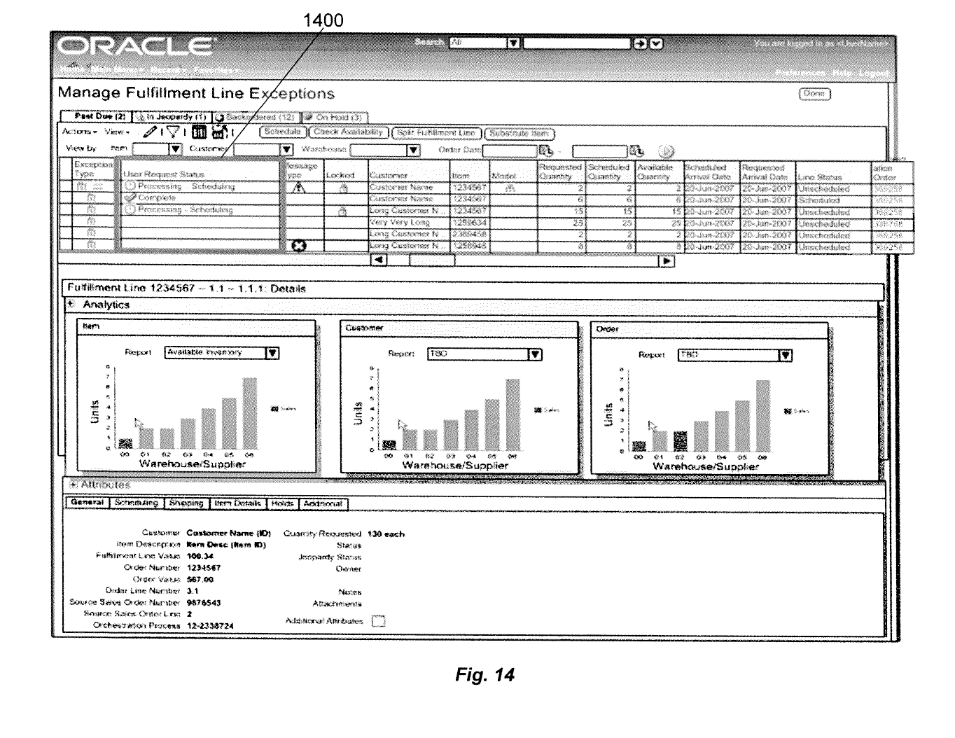

FIG. 14 illustrates a user interface of a fulfillment workbench according to another embodiment of the invention. As previously described in relation to FIG. 13, if a predetermined timeout period has elapsed and a process request initiated by a fulfillment workbench is still processing, the user interface displays an indication that indicates the process request is still processing. As previously described, a process request that is processing after a predetermined timeout period has elapsed is also identified as a pending process request. According to an embodiment, a user can close a window that displays the indication and return to a window displayed by the user interface where the user first initiated the process request. In the illustrated embodiment, the window displayed by the user interface in FIG. 14 is similar to the window displayed by the user interface in FIG. 10 where a user originally scheduled the fulfillment lines. However, according to the illustrated embodiment, the window of FIG. 14 also displays user request status 1400. User request status 1400 is a column of status indicators, where user request status 1400 includes a status indicator for each scheduled fulfillment line. According to the embodiment, the user interface will display one of two status indicators for each scheduled fulfillment line: a complete status indicator that indicates that the line request is complete, and a processing status indicator that indicates that the line request is processing. As previously described, a line request that is processing after a predetermined timeout period has elapsed is also identified as pending line request. The status indicator can take the form of text, a graphical icon, or both, that is displayed by the user interface.

According to an embodiment, the window illustrated in FIG. 14 also includes a refresh button (not shown). When a user selects the refresh button, the fulfillment workbench refreshes the window illustrated in FIG. 14 and displays updated status indicators for each scheduled fulfillment line at user request status 1400. For example, if a scheduled fulfillment line has a processing status before a user selects the refresh button, but has a complete status at the time the user selects the refresh button, the user interface displays a complete status indicator for the scheduled fulfillment line at user request status 1400. According to the embodiment, when a user clicks the refresh button, the fulfillment workbench re-queries a set of data in order to determine a current status for each line request. Then, the fulfillment workbench repaints the window displayed by the user interface, including any updated statuses for corresponding line requests. Regardless of whether any statuses of the line requests have been updated, the fulfillment workbench repaints the window displayed by the user interface.

According to an alternate embodiment, without requiring the user to select a refresh button, or any button at all, the fulfillment workbench can automatically update specific status indicators displayed at user request status 1400 as the fulfillment workbench receives status updates. Thus, a user can keep the window illustrated in FIG. 14 open, and when a line request completes, the fulfillment workbench receives information that the line request has completed, and the user interface automatically updates the corresponding status indicator displayed at user request status 1400, changing a displayed processing status indicator to a complete status indicator. Furthermore, according to the embodiment, other attributes of the fulfillment line displayed at the window illustrated in FIG. 14 can automatically be updated in a similar fashion. For example, a line status for a fulfillment line, displayed by the user interface, with a value of “Unscheduled” can automatically be updated to a value of “Scheduled.” Thus, according to the embodiment, a refresh of the entire window can be avoided.

According to an embodiment of the invention, a database is maintained in the fulfillment workbench that maintains a status of each line request, where each line request is a component of a process request initiated by the fulfillment workbench. When a line request is first processed, a record is created in a database table of the database indicating that the line request has a processing status. When the line request is processed, the record is updated in the database table of the database indicating that the line request has a complete status. According to the embodiment, the database of the fulfillment workbench is separate from the user interface of the fulfillment workbench.

According to the embodiment, the database can be configured to monitor specific columns of specific database tables. The database can be further configured to transmit an update to the user interface upon a change in value of one or more of the specific columns for a specific record. Upon receiving the update, the user interface can update its display to reflect the change in value of one or more of the specific columns. For example, a database table maintained in a database of the fulfillment workbench can include a record which contains a status value in a column that corresponds to a line request that is a component of a process request initiated by the fulfillment workbench. This column can be “tagged” so that the database is configured to monitor this column. When the line request is complete, the value of the corresponding “tagged” column can change from a processing status to a complete status. This change in value can trigger the database to transmit an update to the user interface. Based on the update, the user interface automatically updates its display to indicate that the status of the line request has changed from a processing status to a complete status. Such a display update can include the user interface displaying a different icon in a user request column, displaying different text in the user request column, or both.

According to an embodiment, one mechanism for configuring a database to monitor specific columns of specific database tables, and transmit an update to the user interface upon a change in value of one or more of the specific columns for a specific record, is an active data service. In the embodiment, an active data service binds a user interface component with a data store, such as a database, that publishes events when data is changed. Subsequently, data is pushed to the user interface whenever a change event is raised by the data. On the user interface side, the user interface can be configured to receive the data and update its display based on the received data.

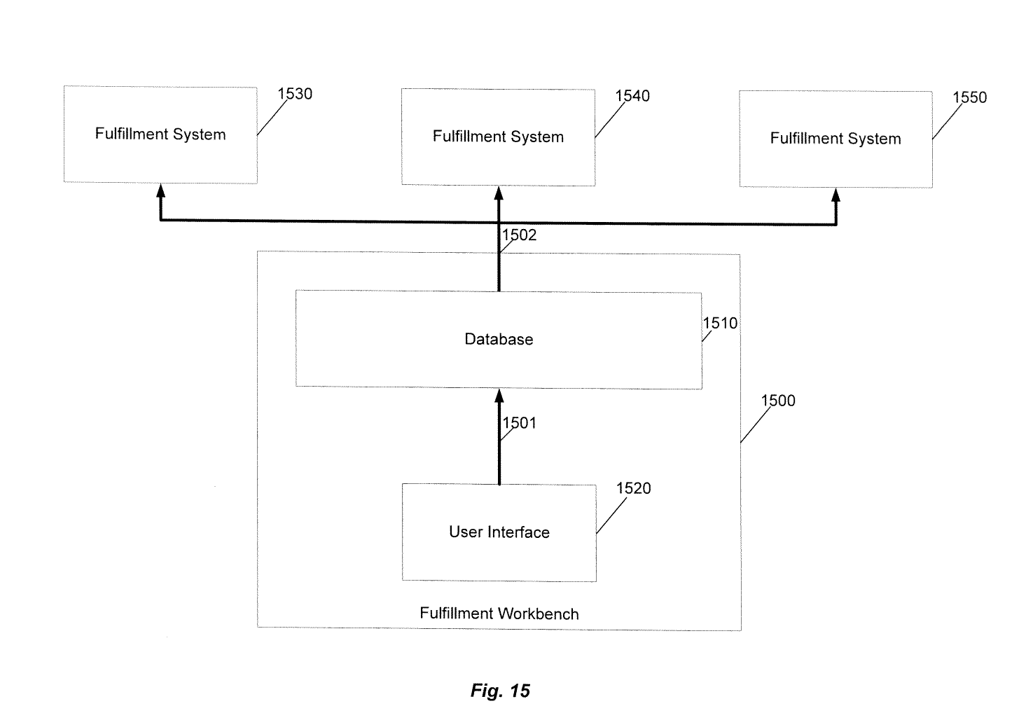

FIGS. 15-20 illustrate a process of initiating a process request and displaying a status of the process request using a fulfillment workbench according to an embodiment of the invention. One of ordinary skill in the art would readily appreciate that the embodiment illustrated in FIGS. 15-20 is merely an example embodiment, and that the requests and responses transmitted from the fulfillment workbench to a set of fulfillment systems, and visa-versa, may follow a different order than the order depicted in FIGS. 15-20, and described in the following paragraphs.

Furthermore, according to the embodiment, the process request involves three lines, and thus, includes three line requests. However, one of ordinary skill in the art would readily appreciate that a process request may involve any number of lines, and thus, include any number of line requests, and still be within the scope of the invention. Thus, the number of lines described in the following paragraphs is merely an example number, and does not limit the number of lines that can be involved in the process request, and does not limit the number of line requests include in the process request.

In addition, as illustrated in FIGS. 15-20, and described in the following paragraphs, the process request involves three fulfillment systems. However, one of ordinary skill in the art would readily appreciate that a process request may involve any number of fulfillment systems and still be within the scope of the invention. Thus, in the illustrated embodiment, the number of fulfillment systems involved in a process request, is merely an example number, and does not limit the number of fulfillment systems that can be involved in a process request.

Finally, as illustrated in FIGS. 15-20, and described in the following paragraphs, the request to modify a fulfillment process includes three line requests, where each line request involves one line of the three lines, and each line request interfaces with a separate fulfillment system. However, one of ordinary skill in the art would readily appreciate that a line request can interface with any number of fulfillment systems and still be within the scope of the invention. Thus, in the illustrated embodiment, the number of fulfillments systems is an example number, and does not limit the number of fulfillment systems that can be involved in the line request.

FIG. 15 illustrates a flow diagram of a fulfillment workbench transmitting a process request to a set of fulfillment systems according to an embodiment of the invention. FIG. 15 illustrates a fulfillment workbench 1500 that includes a database 1510 and a user interface 1520. Database 1510 can be an operational database, an analytical database, a data warehouse, a distributed database, an end-user database, an external database, a navigational database, an in-memory database, a document-oriented database, a real-time database, a relational database, an object-oriented database, or any other database known in the art. User interface 1520 can include hardware and software components, and can be any type of user interface know in the art that allows a user to interface with the fulfillment workbench.

According to an embodiment, when a user submits a process request using user interface 1520, fulfillment workbench 1500 creates a record for each line request of the process request into database 1510, and updates each record with a unique identifier, such as a request tracking number, that identifies the line request as being part of the process request. In the illustrated embodiment, the process request includes three line requests, so fulfillment workbench creates three records into database 1510. According to the embodiment, database 1510 then updates each record with a processing status. Thus, in the illustrated embodiment, each of the three records are updated with a processing status, as illustrated by flow 1501. Subsequently, in the illustrated embodiment, fulfillment workbench 1500 transmits a line request to fulfillment system 1530 to process the first line, transmits a line request to fulfillment system 1540 to process the second line, and transmits a line request to fulfillment system 1550 to process the third line, as illustrated by flow 1502. According to an embodiment, transmitting a line request includes asynchronously calling a web service of an appropriate fulfillment system.

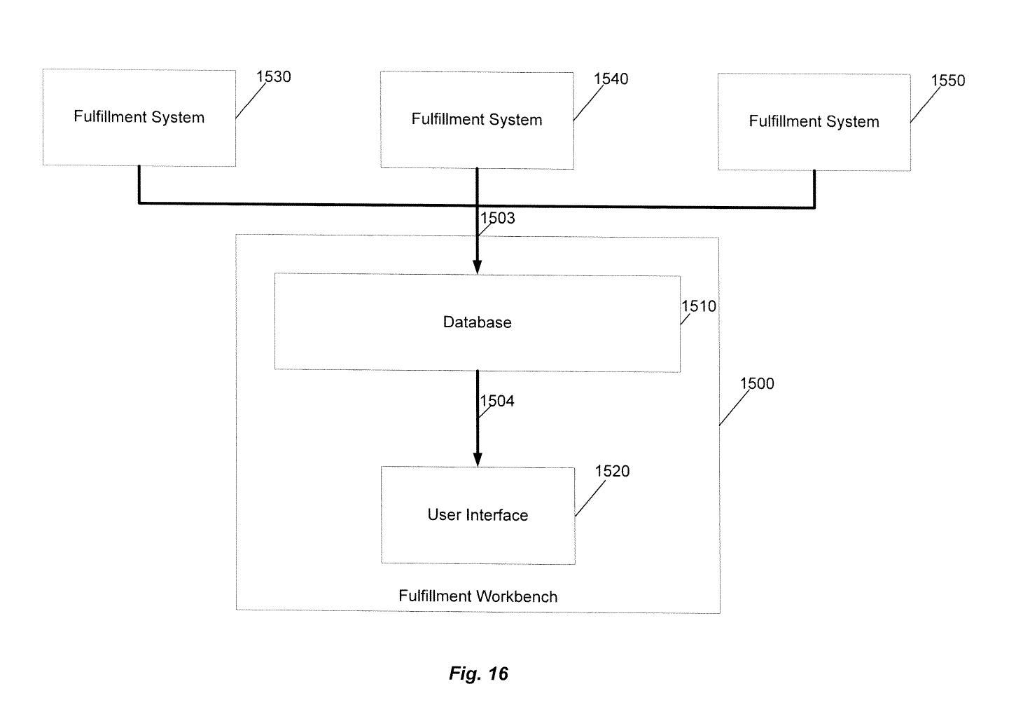

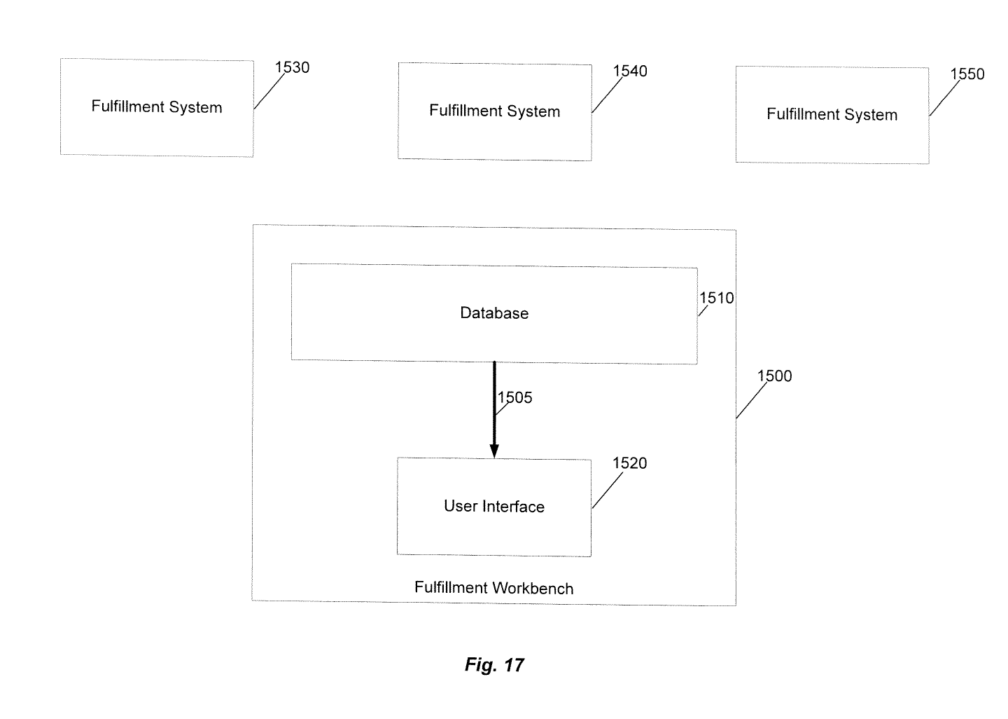

FIGS. 16-20 illustrate two alternate embodiments based on the illustrated embodiment of FIG. 15. More specifically, FIG. 16 illustrates an embodiment where each of the three line requests finish before a predetermined timeout period. FIGS. 17-20 illustrate an alternate embodiment where each of the three line requests finish after a predetermined timeout period. One of ordinary skill in the art would readily appreciate that there can be alternate embodiments where some of the line requests finish before the predetermined timeout period, and some of the line requests finish after the predetermined timeout period.

FIG. 16 illustrates a flow diagram of a fulfillment workbench displaying an indication that a process request is complete according to an embodiment of the invention. According to the embodiment, fulfillment systems 1530, 1540, and 1550 each finish processing a respective line request, and each transmit a notification to fulfillment workbench 1500 indicating that the line request is complete, as illustrated by flow 1503. In response, fulfillment workbench 1500 updates a record corresponding to each line request with a complete status in database 1510, and updates all appropriate data values for the corresponding record in database 1510. Thus, in the illustrated embodiment, fulfillment workbench 1500 updates three records with a complete status. In an embodiment, fulfillment workbench 1500 optionally transmits a notification to a user when each line request is complete. According to the embodiment, the user can determine a method of notification. For example, the notification may be an e-mail message, an instant message, a text message, or a visual display within user interface 1520. As previously described, fulfillment systems 1530, 1540, and 1550 each finish processing a respective line request, and each transmit a notification to fulfillment workbench 1500 indicating that the line request is complete before a predetermined timeout period.

In response to the three records being updated with a complete status in database 1510, fulfillment workbench 1500 transmits a notification to user interface 1520 that the request is complete, as illustrated by flow 1504, and user interface 1520 displays an indication that the process request is complete. According to an embodiment, the indication can be similar to the indication described in relation to FIG. 12. According to an embodiment, the predetermined timeout period can be defined by a user.

FIG. 17 illustrates a flow diagram of a fulfillment workbench displaying an indication that a process request is still processing according to an embodiment of the invention. According to the embodiment, fulfillment systems 1530, 1540, and 1550 do not finish processing a respective line request, and thus, do not transmit a notification to fulfillment workbench 1500 indicating that each line request is complete, before a predetermined timeout period has elapsed. In the embodiment, fulfillment workbench 1500 determines if the process request is complete by monitoring the database table of the database to see if all the records have a complete status. In an embodiment when the database table includes records for multiple process requests, fulfillment workbench 1500 monitors all records which include a unique identifier, such as a request tracking number. In determining that the process request is not complete, fulfillment workbench 1500 transmits a notification to user interface 1520 that the process request is still processing, as illustrated by flow 1505, and user interface 1520 displays an indication that the process request is still processing. According to an embodiment, the indication can be similar to the indication described in relation to FIG. 13. According to an embodiment, the predetermined timeout period can be defined by a user.

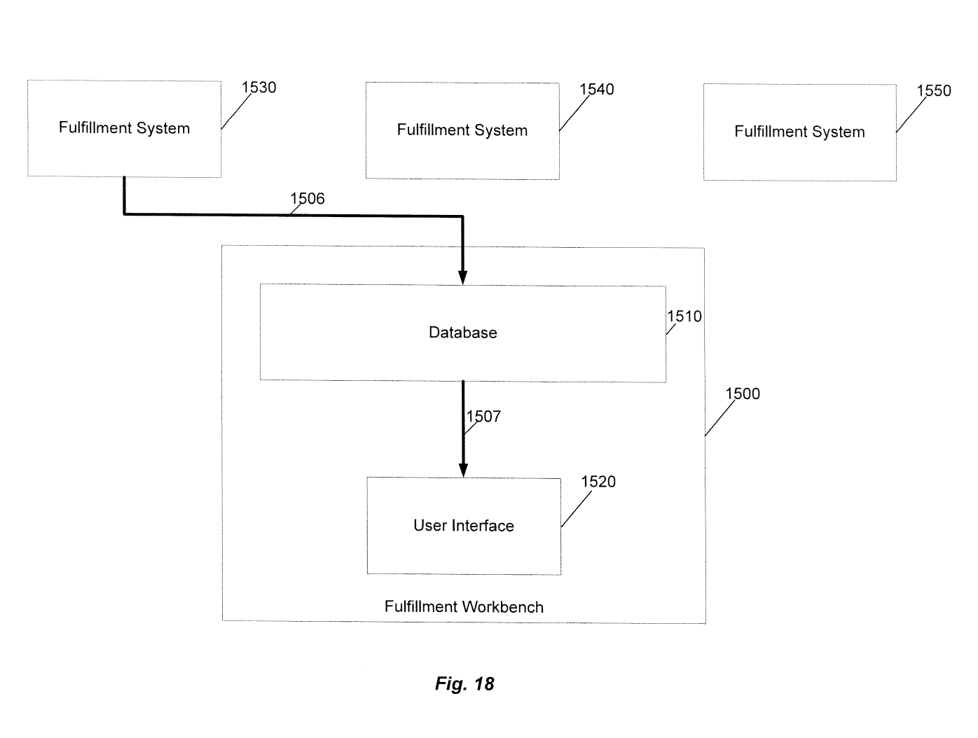

FIG. 18 illustrates a flow diagram of a fulfillment workbench updating a request status for a first line request according to an embodiment of the invention. According to the embodiment, fulfillment system 1530 finishes processing a first line request, and transmits a notification to fulfillment workbench 1500 indicating that the first line request is complete, as illustrated by flow 1506. In response, fulfillment workbench 1500 updates a first record that corresponds to the first line request with a complete status in database 1510, and updates all appropriate data values for the first record in database 1510. Because the predetermined timeout period has already elapsed, fulfillment workbench 1500 leverages an active data service push mechanism when the first record is updated with a complete status, so that database 1510 creates an event and pushes the event to user interface 1520, as illustrated by flow 1507. In a window displaying details for the first line, user interface 1520 displays a column to indicate a request status for the first line request. Upon receiving the event from database 1510, user interface 1520 automatically refreshes a corresponding column to show the updated request status of the first line request, and automatically refreshes any other attributes of the first line that have been updated as well. In an alternate embodiment, a user manually refreshes the window by selecting a refresh button, and user interface 1520 manually refreshes the displayed window, where the new window shows the updated request status of the first line request and any other updated attributes of the first line.

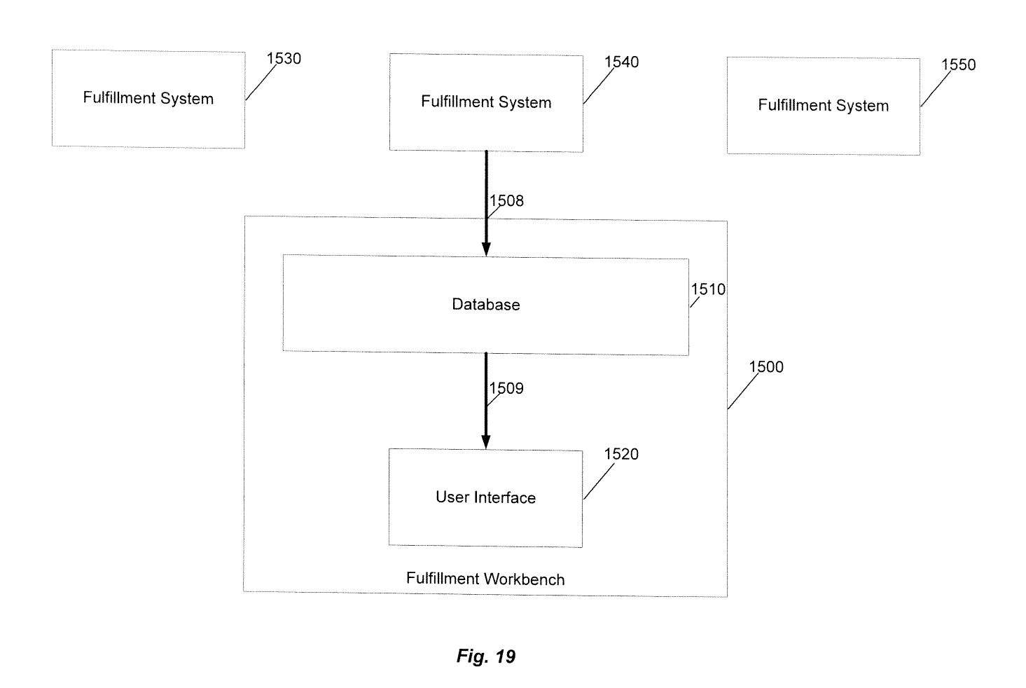

FIG. 19 illustrates a flow diagram of a fulfillment workbench updating a request status for a second line request according to an embodiment of the invention. According to the embodiment, fulfillment system 1540 finishes processing a second line request, and transmits a notification to fulfillment workbench 1500 indicating that the line request is complete, as illustrated by flow 1508. In response, fulfillment workbench 1500 updates a second record that corresponds to the second line request with a complete status in database 1510, and updates all appropriate data values for the second record in database 1510. Because the predetermined timeout period has already elapsed, fulfillment workbench 1500 leverages an active data service push mechanism when the second record is updated with a complete status, so that database 1510 creates an event and pushes the event to user interface 1520, as illustrated by flow 1509. In a window displaying details for the second line, user interface 1520 displays a column to indicate a request status for the second line request. Upon receiving the event from database 1510, user interface 1520 automatically refreshes a corresponding column to show the updated request status of the second line request, and automatically refreshes any other attributes of the second line that have been updated as well. In an alternate embodiment, a user manually refreshes the window by selecting a refresh button, and user interface 1520 manually refreshes the displayed window, where the new window shows the updated request status of the second line request and any other updated attributes of the second line.

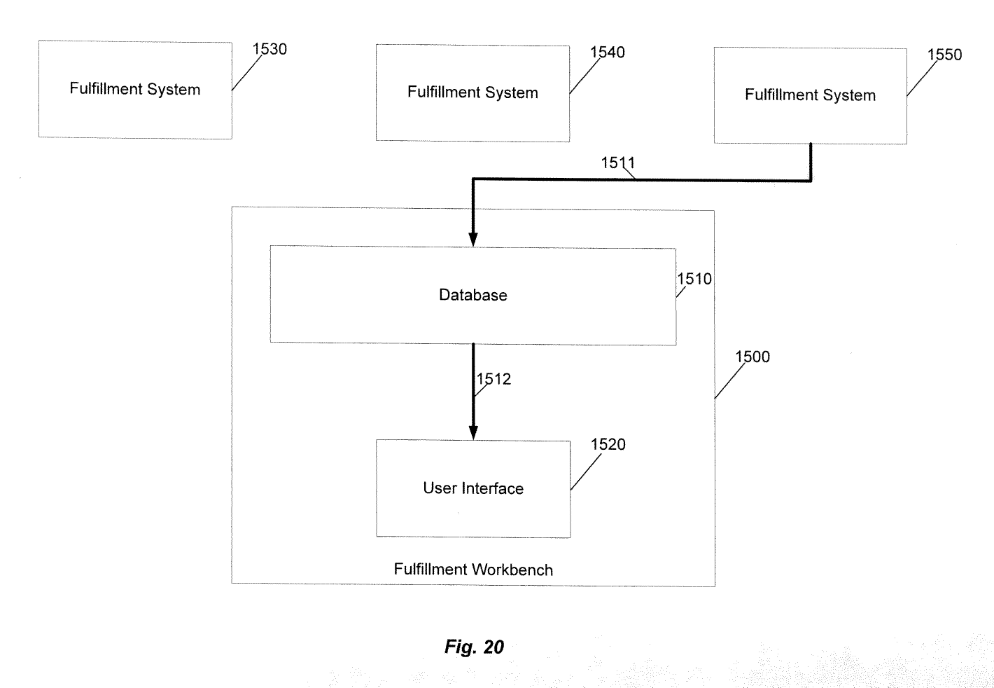

FIG. 20 illustrates a flow diagram of a fulfillment workbench updating a request status for a third line request according to an embodiment of the invention. According to the embodiment, fulfillment system 1550 finishes processing a third line request, and transmits a notification to fulfillment workbench 1500 indicating that the line request is complete, as illustrated by flow 1511. In response, fulfillment workbench 1500 updates a third record that corresponds to the third line request with a complete status in database 1510, and updates all appropriate data values for the third record in database 1510. Because the predetermined timeout period has already elapsed, fulfillment workbench 1500 leverages an active data service push mechanism when the third record is updated with a complete status, so that database 1510 creates an event and pushes the event to user interface 1520, as illustrated by flow 1512. In a window displaying details for the third line, user interface 1520 displays a column to indicate a request status for the third line request. Upon receiving the event from database 1510, user interface 1520 automatically refreshes a corresponding column to show the updated request status of the third line request, and automatically refreshes any other attributes of the third line that have been updated as well. In an alternate embodiment, a user manually refreshes the window by selecting a refresh button, and user interface 1520 manually refreshes the displayed window, where the new window shows the updated request status of the third line request and any other updated attributes of the third line.

In an embodiment of the invention, if one or more process requests are still processing, a fulfillment workbench can optionally control subsequent actions performed by a user of the fulfillment workbench. For example, the fulfillment workbench can restrict a subsequent action performed by a user until the one or more process requests have completed. As another example, the fulfillment workbench can allow a subsequent action to be performed concurrently with the processing of the one or more process requests. As another example, the fulfillment workbench can queue a subsequent action so that the subsequent action is not invoked until the one or more process requests have completed.

In another embodiment of the invention, a fulfillment workbench can include a batch program that purges process requests completed within a predetermined time period. According to the embodiment, the batch program can take multiple inputs. Such inputs include a user identity, a date range, a status, and a request type. According to the embodiment, a user interface of a fulfillment workbench can be cleaned up over time to erase the visual queues displayed by the user interface for the completed process requests.

FIG. 21 illustrates a flow diagram of the functionality of a fulfillment workbench module according to an embodiment of the invention. At 2110, a process request is transmitted to one or more fulfillment systems. The process request modifies a fulfillment process and includes one or more line requests. At 2120, a first indication that indicates the process request is complete is displayed in a user interface when the process request completes. At 2130, a second indication that indicates that the process request is processing is displayed in the user interface when a predetermined timeout period elapses before the process request completes. At 2140, a status for each line request of the one or more line requests is displayed in the user interface. At 2150, the status for each pending line request of the one or more line requests is automatically updated in the user interface when each pending line request completes. According to an embodiment, a pending line request is a line request that is still processing, after the predetermined timeout period elapses.

Thus, according to an embodiment, a fulfillment workbench can transmit a process request to one or more fulfillment systems, where a process request includes one or more line requests. The fulfillment workbench can subsequently display a status of the process request and a status of each of the line requests to a user via a user interface. The status of each of the pending line requests can be automatically updated by the fulfillment workbench as each pending line request completes.

According to the embodiment, the fulfillment workbench shows the correct status indicators directly in the user interface of the fulfillment workbench, so that a user has direct feedback as well as a proactive notification of the completion of a process request, via any delivery mechanism chosen by the user. Furthermore, the fulfillment workbench allows a user to take actions while waiting for a response to a process request.

The features, structures, or characteristics of the invention described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present invention. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the invention as discussed above may be practiced with steps in a different order, and/or with elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A computer-readable medium having instructions stored thereon that, when executed by a processor, cause the processor to manage a process request in a distributed order orchestration system, the instructions comprising:
transmitting a process request to one or more fulfillment systems, wherein the process request modifies a fulfillment process, and wherein the process request comprises one or more line requests;
displaying a first indication indicating that the process request is complete in a user interface, when the process request completes;
displaying a second indication indicating that the process request is processing in the user interface, when a predetermined timeout period elapses before the process request completes;
displaying a status for each line request of the one or more line requests in the user interface; and
automatically updating the status for each pending line request of the one or more line requests in the user interface, when each pending line request completes.

2. The computer-readable medium of claim 1, the instructions further comprising:
creating a record in a database table of a database for each line request of the one or more line requests;
updating each record in the database table indicating that the corresponding line request has a complete status, when the corresponding line request completes;
monitoring the records in the database table to see if all corresponding line requests have a complete status, when the predetermined timeout period elapses; and
transmitting, in the database, an update to the user interface when each record in the database table corresponding to a pending line request is updated, wherein the user interface automatically updates its display to indicate that the status of the corresponding pending line request has been updated.

3. The computer-readable medium of claim 2, wherein the user interface automatically updates its display to indicate that the status of the corresponding pending line request has been updated from a processing status to a complete status.

4. The computer-readable medium of claim 2, wherein the user interface automatically updates its display by at least one of, displaying a different icon in a column of the user interface, and displaying different text in the column of the user interface.

5. The computer-readable medium of claim 2, wherein the update comprises an event published by an active data service.

6. The computer-readable medium of claim 1, wherein the predetermined timeout period comprises a system parameter.

7. The computer-readable medium of claim 6, wherein the system parameter is configured by a user.

8. The computer-readable medium of claim 1, wherein displaying the first indication and displaying the second indication each further comprise displaying a unique identifier of the process request.

9. The computer-readable medium of claim 1, wherein displaying the first indication and displaying the second indication each further comprise displaying one or more error messages received from the one or more fulfillment systems.

10. The computer-readable medium of claim 1, the instructions further comprising automatically updating other attributes for each pending line request of the one or more line requests in the user interface, when each pending line request completes.

11. The computer-readable medium of claim 1, the instructions further comprising transmitting a notification to a user for each pending line request of the one or more line requests in the user interface, when each pending line request completes.

12. The computer-readable medium of claim 11, wherein the notification comprises at least one of, an e-mail message, an instant message, a text message, or a visual display within a user interface.

13. The computer-readable medium of claim 1, the instructions further comprising controlling subsequent actions performed by a user while the process request is processing.

14. The computer-readable medium of claim 13, wherein the controlling subsequent actions further comprises at least one of, restricting a subsequent action performed by the user until the process request has completed, allowing a subsequent action to be performed concurrently with the processing of the process request, and queuing a subsequent action so that the subsequent action is not invoked until the process request has completed.

15. The computer-readable medium of claim 1, the instructions further comprising purging, using a batch program, process requests completed within a predetermined time period.

16. A computer-implemented method for managing a process request in a distributed order orchestration system, the computer-implemented method comprising:
transmitting a process request to one or more fulfillment systems, wherein the process request modifies a fulfillment process, and wherein the process request comprises one or more line requests;
displaying a first indication indicating that the process request is complete in a user interface, when the process request completes;
displaying a second indication indicating that the process request is processing in the user interface, when a predetermined timeout period elapses before the process request completes;
displaying a status for each line request of the one or more line requests in the user interface; and
automatically updating the status for each pending line request of the one or more line requests in the user interface, when each pending line request completes.

17. The computer-implemented method of claim 16, further comprising:
creating a record in a database table of a database for each line request of the one or more line requests;
updating each record in the database table indicating that the corresponding line request has a complete status, when the corresponding line request completes;
monitoring the records in the database table to see if all corresponding line requests have a complete status, when the predetermined timeout period elapses; and
transmitting, in the database, an update to the user interface when each record in the database table corresponding to a pending line request is updated, wherein the user interface automatically updates its display to indicate that the status of the corresponding pending line request has been updated.

18. The computer-implemented method of claim 17, wherein the user interface automatically updates its display to indicate that the status of the corresponding pending line request has been changed from a processing status to a complete status.

19. A fulfillment workbench, comprising:
a memory configured to store instructions;
a processor configured to execute the instructions stored on the memory; and
a user interface configured to display data,
wherein the processor is further configured, when executing the instructions stored on the memory, to
transmit a process request to a fulfillment system, and wherein the process request comprises a set of line requests,
when the process request completes, display a first indication that indicates the process request is complete in the user interface,
when a predetermined timeout period elapses before the process request completes, display a second indication that indicates the process request is processing in the user interface,
display a status for each line request of the set of line requests in the user interface, and
when each pending line request completes, automatically update the status for each pending line request of the set of line requests in the user interface.

20. The fulfillment workbench of claim 19, further comprising:
a database configured to store a set of records,
wherein the processor is further configured, when executing the instructions stored on the memory, to
create a record in a database table of the database for each line request of the set of line requests,
update each record in the database table indicating that the corresponding line request has a complete status, when the corresponding line request completes,
monitor the records in the database table to see if all corresponding line requests have a complete status, when the predetermined timeout period elapses, and
transmit, in the database, an update to the user interface when each record in the database table corresponding to a pending line request is updated, wherein the user interface automatically updates its display to indicate that the status of the corresponding pending line request has been updated.
